(19) United States
(12) Patent Application Publication
(10) Pub. No.: US 2008/0106745 A1
(43) Pub. Date: May 8, 2008

(54) METHOD AND APPARATUS FOR HIGH FREQUENCY OPTICAL SENSOR INTERROGATION

(76) Inventors: Todd C. Haber, Alpharetta, GA (US); Joel L. Mock, Norcross, GA (US); James Kraus, Duluth, GA (US)

Correspondence Address: GREENLEE WINNER AND SULLIVAN P C, 4875 PEARL EAST CIRCLE, SUITE 200, BOULDER, CO, 80301, US

(21) Appl. No.: 11/848,028

(22) Filed: Aug. 30, 2007

Related U.S. Application Data
(60) Provisional application No. 60/824,266, filed on Aug. 31, 2006.

(51) Int. Cl. G01B 9/02

(52) U.S. Cl. 356/519

(57) ABSTRACT

Optical sensor measurement methods that convert a wavelength change in an optical sensor to a measurable optical intensity change, which can be calibrated and used to measure optical wavelength change and environmental changes such as temperature or strain which affect sensor wavelength. The current invention makes use of tunable fiber Fabry-Perot filters as the wavelength selective elements for the wavelength to optical intensity conversion. The invention provides high measurement sensitivities to small amplitude, high frequency modulations to the fiber sensor center wavelength, accommodates for system drift from thermal or other perturbations, and enables either frequency mode or time varying resolution of sensor modulation events. Selection of proper Fabry-Perot optics allow for measurement optimization of either high sensitivity or high strain measurement range.

### CROSS-REFERENCE TO RELATED APPLICATIONS

This application takes priority from U.S. provisional application 60/824,266, filed Aug. 31, 2006, which is incorporated in its entirety by reference herein.

### BACKGROUND OF THE INVENTION

In the past few years, fiber Bragg grating optical sensors have gained acceptance in the market as an alternative to conventional electronic gages. In many applications, including among others, civil structure monitoring, down hole oil and gas applications, marine and aerospace applications, fiber optic sensor systems offer several advantages over conventional gages. Unlike electronic sensors, fiber-based sensors are immune to electromagnetic interference and are well suited to electrically noisy environments. Fiber-based gages can be made very small and lightweight for use in confined spaces. Fiber-based gages can also be made to withstand high temperature and corrosive environments.

Current fiber Bragg grating sensor systems are typically capable of taking measurements at rates of several Hertz to several hundred Hertz. A new body of applications for optical sensors is emerging in the fields of power generation, blast analysis, or electromagnetic rail gun testing, which requires a reliable and accurate method of measuring fiber optic sensor center wavelength changes at rates much higher than conventional applications, often up to rates as high as 250-500 kHz. The current invention relates to a method and apparatus designed to measure and characterize center wavelength changes of optical sensors at rates of hundreds of Hertz into the mega Hertz range.

Several types of wavelength selective elements have been used to translate sensor wavelength changes into optical intensity variation. The highly sloped edges of optical thin film edge filters have been used to enable ratiometric intensity measurements for monitoring high speed optical sensor wavelength modulations. While the use of edge filters can support high speed measurements, the wavelength range of the sloped transmission section of such filters can be rather narrow, requiring that very specific wavelength sensors be used.

Wider sloping regions in thin film filters, often referred to as Linear Attenuation Filters (LAFs) have been designed to increase the available wavelength range for the sensors. A typical LAF spectrum varies nearly linearly from >95% reflection to <5% reflection over a particular wavelength range, e.g., 1520-1570 nm. Reduction of the slope in the transmission spectrum allows the use of a wider variety of sensor wavelengths in a LAF-based measurement system, but the benefit is offset by the reduction in transmission contrast per unit wavelength. With a lower transmission slope, the optical intensity variation per unit sensor wavelength shift is reduced, thus reducing the measurement sensitivity of the system designed with a LAF.

In addition to the performance tradeoffs described above, the use of thin film optical filters adds an additional complication for high-speed, high sensitivity fiber Bragg grating measurements. The optical transmission profiles of thin film optical filters commonly exhibit ripple of varying degrees, often of magnitude 0.1-0.2 dB or more. Such ripple on an edge filter or LAF can result in a non-monotonic feature in the transmission profile. Ratiometric measurements made using wavelength selective elements require that there be a unique power ratio for each wavelength in the measurement range. Any ripple in the edge filter or LAF used for such measurements will cause ambiguity in wavelength or wavelength change measurements. The resulting measurements can exhibit erroneous wavelength data in the time domain, or fictitious/misrepresented spectral features in the frequency domain. The present invention provides methods and apparatus for high frequency measurement that overcome the problems of prior art systems.

### SUMMARY OF THE INVENTION

The present invention provides a method and apparatus for measurement and characterization of center wavelength changes of optical sensors at rates of greater than 100 Hz. The methods and apparatus of this invention function for measurement of such wavelength changes at rates ranging from 100 Hz to several MHz and are particularly useful for measurement in the frequency range of 100 Hz to 500 kHz. The method and apparatus of this invention provide for measurements with extremely high sensitivity, accurately resolving fundamental vibration mode frequencies of signals with as little as 0.02 pm RMS (root mean square) modulation. The invention employs wavelength selective elements (i.e., wavelength filters) that have smooth, ripple-free optical power transmission profiles and which can be actively tuned. A smooth, monotonic change in filter optical power transmission as a function of wavelength allows for very small changes in optical sensor wavelength to be detected, without ambiguity from filter ripple. Active tuning of the filter allows for active accommodation for any slowly varying drift phenomenon (thermal or other) that may occur over time such that the desired filter operating point for maximum measurement sensitivity and filter linearity are maintained. Additionally, the ability to tune the filter provides measurement capability for optical sensors at a wider range of wavelengths within the range of the broadband source, without requiring specific wavelength regions or “bins” for the DUT sensors.

In specific embodiments, the systems and methods of the invention employ fiber Fabry-Perot filters (FFPs) as wavelength selective elements. The transmission profiles of FFPs are typically extremely smooth and free from ripple, compared to other wavelength selective element technologies. FFPs can be actively tuned, using electromechanical transducers, such as PZTs. In addition, the use of fiber Fabry-Perot filters provides for flexibility in design of the wavelength selective element, allowing measurement sensitivity and measurement range tradeoffs in the measurement system to be made by simple changes in Fabry-Perot filter selected.

Bias voltage feedback to the tunable filters is performed at such a rate as to fully compensate for any reasonable thermal drift in the measurement substrate and sensor while minimizing the effects of dynamic tuning of the filter components for the duration of a measurement event. Specifically, thermal compensation is performed at a slow rate of 1 to 100 Hz, as needed. Measurements made by the system are typically on the order of 1 to 20 ms, during which time voltage tuning is not performed, such that the resulting AC strain measurements are not affected by voltage tuning of the filters. Alternately, bias control of the filters components can be implemented continuously, via a separate data acquisition and control loop.

An object of this invention is to allow high speed, high resolution measurement of optical sensors, including strain gages in both modes of continuous vibration and shock response. Examples of continuous sensor vibrations might be seen in engines, turbines, or civil structures. Shock response events might be seen in applications such as ballistics testing or acoustic emissions monitoring.

A unique property of the invention is the modular nature of the TF properties in the design of the measurement system, as it pertains to measurement specifications and capabilities. Performance specifications of the Fabry-Perot filter are selected to dictate the measurement range, sensitivity, and resolution of the resultant strain system. For example, for a typical optical strain sensor with 1.2 pm/με gage factor, a TF with FSR=0.8 nm in the 1.5 μm wavelength range will provide a measurement range of +/−50 με, with a high sensitivity of ˜0.01 με. Selection of a TF with FSR of 16 nm yields an increased measurement range of +/−1000 με, with a correspondingly reduced sensitivity. The control and processing electronics of the present invention will support either TF configuration in the same way, such that the optimization of measurement parameters is dictated solely by the selection of TF properties.

Selection of TF finesse is an essential element of the present invention. As the Fabry-Perot transmission profile is inherently non-linear, there is an optimal range of finesses for application in the present invention. Too low a finesse, like 2 to 5, will result in an unacceptably low contrast factor, limiting the ultimate sensitivity of the measurement system. Too high a finesse, like 20 to 100, will yield such a highly non-linear change in attenuation with change in resonant wavelength of the measured sensor that sufficient compensation for non-linearity cannot be practically performed.

The present invention includes a method for compensating for the non-linear attenuation profile of the Fabry-Perot measurement profile. This calibration methodology is a core component to the capabilities of the measurement system.

In a specific embodiment, the invention provides a high speed optical strain gage measurement system comprising the following components in optical communication:
a broadband optical source;
one or more optical couplers for sharing broadband source power among multiple measurement arms wherein a measurement channel can be optically coupled to an optical sensor, particularly an optical strain gage having an optical output the wavelength of which is sensitive to strain applied to the strain gage;
for each measurement arm one or more tunable fiber Fabry-Perot filters for conversion of wavelength change to optical intensity change;
one or more optical circulators or optical couplers for directing light propagation from an optical strain gage to at least a portion of the one or more fiber Fabry-Perot filters; and
electronic control for periodic tuning of the one or more tunable fiber Fabry-Perot filter such that a selected wavelength peak of the transmission profile of each of the tunable fiber Fabry-Perot filters is tuned to be offset at a selected wavelength offset from the center wavelength of the optical sensor the output of which is coupled to the fiber Fabry-Perot filter.

In specific embodiments, the sensor interrogation system comprises fiber Fabry-Perot tunable filters having finesse ranging from 8-12. In more specific embodiments, the sensor interrogation system comprises fiber Fabry-Perot tunable filters having finesse of 10.

In specific embodiments, the sensor interrogation system comprises fiber Fabry-Perot tunable filters having FSR ranging from 0.5 nm to 100 nm. In other specific embodiments, the sensor interrogation system comprises fiber Fabry-Perot tunable filters having FSR of 0.5 nm to 1 nm, FSR of 12-20 nm, and/or FSR of 60 to 100 nm.

In specific embodiments of the sensor interrogation system, the ratio of the output of the optical sensor coupled into the reference channel to that coupled into the one or more active channels of a measurement arm ranges from 1:1 to 1:4.

Sensor interrogation systems of this invention can have one active channel in each measurement arm. In specific embodiments in which there is one active channel the FSR of the fiber Fabry-Perot tunable filter of that channel can have FSR between 0.6 and 1 nm, between 12 and 20 nm, or between 60-100 nm.

Sensor interrogation system of this invention can have more than one active channel in each measurement arm any one of claims 1-6 wherein the measurement arm contains more than one active channel. In specific embodiments in which there is more than one active channel the FSR of the fiber Fabry-Perot tunable filter of the active channels can have the same finesse, but different FSR. In more specific embodiments, in sensor interrogation systems having more than one active channel in a measurement arm at least one active channel comprises a fiber Fabry-Perot tunable filter having FSR between 0.6 and 1 nm, one active channel having a fiber Fabry-Perot tunable filter having FSR between 12 and 20 nm, and one active channel having a fiber Fabry-Perot tunable filter having FSR between 60-100 nm.

More specifically, the invention provides a sensor interrogation system for measurement of high frequency changes in center wavelengths of one or more than one optical sensors comprising a broadband source for providing broadband output to one or more than one optical sensor; one or more than one sensor measurement arm, wherein each arm can receiving the output of one of the one or more than one optical sensors, wherein a measurement arm comprises a reference channel and one or more active channels where a reference channel comprises a reference photodetector and each active channel comprises a fiber Fabry-Perot tunable filter and a photodetector. The system also comprises electronic control for tuning the wavelength of each fiber Fabry-Perot tunable filter of the system to maintain a selected pre-determined offset from the center wavelength of the optical sensor to which it is optically coupled. In this system the optical output of the source is optically coupled to the one or more optical sensor and the reflected wavelength of each of the one or more optical sensor is optically coupled into one of the one or more measurement arms, in each measurement arm the reflected wavelength of one optical sensor is coupled into the reference channel and the one or more active channels of one measurement arm. The reflected wavelength of the optical sensor coupled into the reference channel is detected at the reference photodetector and the reflected wavelength of the same optical sensor coupled into the one or more active channels is passed through the fiber Fabry-Perot tunable filter of each active channel prior to detection at the photodetector of an active channel. The selected offset of each fiber Fabry-Perot is periodically maintained by an electronic controlled feedback loop.

The invention provides interrogation or measurement systems that can be coupled to optical sensors as well as optical sensor systems comprising one or more optical sensors in which the interrogation system is optically coupled to the one or more optical sensors. In specific embodiments, the invention provides optical strain sensors. In specific embodiments, the optical stain sensor systems comprise fiber Bragg gratings as sensor elements.

The invention provides methods of measuring a change in center wavelength of an optical sensor using the measurement systems of this invention as well as methods for detecting high frequency changes in temperature or strain employing sensor systems of this invention in which fiber Fabry-Perot filters are offset tuned to the center wavelength of the optical sensors being interrogated.

More specifically, the invention provides a method for interrogating one or more optical sensors to detect changes in center wavelengths thereof which comprises the steps of coupling output from a broadband source into the one or more optical sensors; coupling reflected output from each of the one or more optical sensors into a measurement arm of a sensor interrogation system of this invention and for each measurement arm determining the ratio of optical power passing through the reference arm and each active arm at a selected high frequency over a selected time period thereby detecting changes in the center wavelength of the optical sensor coupled to the measurement arm over that time period. Power ratio data is collected for the measurement of the change in center wavelength of an optical sensor only from those measurement arms in which the wavelength of the fiber Fabry-Perot filter is maintained at the pre-selected offset from the center wavelength of the optical sensor. The pre-selected offset is maintained by periodically calculating an average change in center wavelength of the optical sensor coupled to a measurement arm using the power ratios measured from that measurement arm. If the peak wavelength of a given fiber Fabry-Perot filter is found not to be offset at the pre-selected wavelength difference (offset) from the peak of the center wavelength of the optical sensor to which it is optically coupled, a bias is applied to the tunable filter to correct the offset.

In a more specific embodiment of the measurement system of this invention, the Fabry-Perot filter design parameters are matched to the desired measurement range and sensitivity of the measurement system. In a specific embodiment of the measurement system of this invention, the Fabry-Perot filter is offset tuned and locked from the mean resonance wavelength of DUT FBG sensor. In a specific embodiment, the total integrated power of the output of serially connected FP and FBG filters are used to measure AC changes in wavelength of an optical sensor. In a specific embodiment, non-linear changes in total integrated power as related to linear changes in FP and FBG resonance offset are calibrated and used to determine wavelength changes in an optical sensor. In yet another embodiment of the measurement system of this invention, DC changes in resonance offset between FP and FBG sensor are compensated through bias voltage changes to the tunable filters. In an embodiment of the measurement system of the invention, measurements of continuous sensor vibration modes are made. In an embodiment of the measurement system of the invention, triggered measurements of “impact events” are made.

In a more specific embodiment of the measurement system of this invention, the Fabry-Perot filter is offset tuned and locked from the mean resonance wavelength of DUT FBG sensor, the total integrated power of the output of serially connected FP and FBG filters are used to measure AC changes in wavelength of an optical sensor and non-linear changes in total integrated power as related to linear changes in FP and FBG resonance offset are calibrated and used to determine wavelength changes in an optical sensor. In a further more specific embodiment, DC changes in resonance offset between FP and FBG sensor are compensated through bias voltage changes to the tunable filters. More specifically in this embodiment, measurements of continuous sensor vibration modes are made. More specifically, in this embodiment, triggered measurements of “impact events” are made.

The invention relates to methods for measurement and characterization of center wavelength changes of optical sensors employing the measurement system of this invention. More specifically, the measurements of center wavelength changes are made at rates of 100s of Hz into the MHz range. The invention specifically provides methods for high frequency detection of strain in an object under test using the sensor interrogation systems and sensor systems of this invention.

The invention employs any FP filter that exhibits the characteristics noted herein above. In particular, the invention can employ all-Fiber Fabry Perot tunable filters, particularly those which are tuned employing piezoelectric transducers (PZTs).

The invention is further described by reference to the detailed description and drawings which follow.

### BRIEF DESCRIPTION OF THE DRAWINGS

FIG. 1A is a schematic drawing illustrating the optical circuit for an exemplary high speed strain measurement system of the present invention.

FIG. 1B is a schematic drawing illustrating the optical circuit for an alternative exemplary high speed strain measurement system of the present invention, in which the optical circulator is replaced with an optical coupler

FIG. 1C is a schematic drawing illustrating the optical circuit for another alternative exemplary high speed strain measurement system of the present, in which more than one tunable filter are used in parallel on a receiver circuit, thereby facilitating simultaneous measurements of a single sensor at multiple ranges and sensitivity levels.

FIG. 1D is a schematic drawing illustrating the optical circuit for another alternative exemplary high speed strain measurement system of the present invention, in which both the transmitted and reflected signal from the FFP are used to determine the bias (offset) position of the FFP output relative to that of the FBG sensor. As the reflection and transmission properties of the FP are complimentary, the ratio of these two signals is intrinsically self-referencing for any fluctuations in the returned power of the FBG.

FIG. 2 is a graphic illustration of the optical interaction between the optical signal from a Fiber Bragg Grating DUT (Device under Test) and the Fabry Perot measurement optics of systems of this invention. The figure illustrates positioning a peak of the output spectrum of an FP filter offset from the peak wavelength of the FBG output signal. The FP wavelength peak is periodically tuned to maintain or lock to a selected offset.

FIG. 3A is a block diagram schematic of an example electrical data acquisition and electrical control system that interfaces the optical circuitry of exemplary measurement systems of this invention. The electrical control provides for periodic tuning of the wavelength of the FP filter to maintain or lock the offset.

FIG. 3B is a block diagram schematic of an alternative exemplary electrical data acquisition and electrical control system that interfaces the optical circuitry of exemplary measurement systems of this invention. The electrical control provides for periodic tuning of the wavelength of the FP filter to maintain or lock the offset.

FIG. 3C is a block diagram schematic of another alternative exemplary electrical data acquisition and electrical control system that interfaces the optical circuitry of exemplary measurement systems of this invention. The electrical control provides for periodic tuning of the wavelength of the FP filter to maintain or lock the offset. This system is an analog, closed-loop, electronic servo control system that calculates the ratio of total integrated optical power to the wavelength dependent attenuated optical power. The output of the divider represents the device under test wavelength. To maintain calibration the output of the divider is scaled, averaged and compared to a calibration set-point level. The difference amplifier output (error signal) is scaled, buffered and used to control the tunable filter.

FIG. 3D is a block diagram schematic of another alternative exemplary electrical data acquisition and electrical control system that interfaces the optical circuitry of exemplary measurement systems of this invention. The electrical control provides for periodic tuning of the wavelength of the FP filter to maintain or lock the offset. This system is an analog, closed-loop, electronic servo control system that uses logarithmic amplifiers to calculate the ratio of total integrated optical power to the wavelength dependent attenuated optical power by simple subtraction.

FIG. 4A is a flowchart showing the basic software or firmware functions of the invention in a particular embodiment of a system of the invention.

FIG. 4B is a flowchart for an alternative embodiment of the invention, in which tunable filter control is performed by an independent control loop.

FIG. 5 is a plot of resultant measurement data from a vibration mode analysis, demonstrating the frequency response and sensitivity of an exemplary measurement system of the invention.

FIG. 6A is a plot of the time varying strain signal of an impact event on a body (DUT) instrumented with an optical strain gage (containing an FBG), as measured by a high speed strain measurement system of the invention. The time domain signal of the impact event is trapped with a Software FFT level trigger.

FIG. 6B is a plot of the frequency domain spectrum of the impact event of FIG. 6A, with the X axis scaled to show detail in the 0 to 20,000 Hz range.

FIG. 6C is a plot of the frequency domain spectrum of the impact event of FIG. 6A, with the X axis scaled to full, to show the full frequency response of the measurement system.

FIG. 7A is a spectral model of an idealized TF transmission (dashed line) and FBG sensor reflection (FBG) profile.

FIG. 7B is the spectral model of FIG. 7A overlayed with a plot of the combined throughput of the reflected FBG sensor profile as transmitted through the TF profile (thick solid line).

FIG. 8 is a plot of a typical calibration curve of a system of this invention, showing power ratio versus wavelength offset.

FIG. 9A is spectral model of the TF transmission, the FBG sensor output and the combined throughput of the FBG sensor profile transmitted through the TF profile when the wavelength peaks of the FBG and the TF are near alignment.

FIG. 9B is a spectral model as in FIG. 9A when the wavelength peaks of the FBG and the TF are significantly misaligned (significantly offset).

FIG. 10A is plot comparing the contrast properties of a system having an TF with finesse 10 TF (top curve) compared to that of a system having a TF with a finesse 40 (bottom curve). The use of the F 40 TF provides a smaller range of acceptably linear transmission slope needed to provide wide measurement range and is not preferred.

FIG. 10B is a plot comparing the contrast properties of a system having an TF with finesse 10 TF (bottom curve) compared to that of a system having a TF with a finesse 3 (top curve). The use of the TF with Finesse 3 results in lower contrast than that needed to provide for good measurement sensitivity and is not preferred.

FIG. 11 is a plot of the calibration curve for a system having a TF with FSR 0.800 nm wherein the FBG of the strain gage has BW (band width) of 0.5 nm (a Regime 1 design). Note that the curve is non-linear and non-monotonic.

FIG. 12A is a spectral model of the TF transmission, the FBG sensor output and the combined throughput of the FBG sensor profile transmitted through the TF profile of a system as in FIG. 11 (Regime 1) when the wavelength peaks of the FBG and the TF are near alignment.

FIG. 12B is a spectral model of the TF transmission, the FBG sensor output and the combined throughput of the FBG sensor profile transmitted through the TF profile of a system as in FIG. 11 (Regime 1) when the wavelength peaks of the FBG and the TF are significantly misaligned or offset.

FIG. 13 is a plot of the calibration curve for a Regime 1 design, with the preferred operation range indicated by the dotted line box where positions C and D represent the minimum preferred offset and the maximum preferred offset. Positions C and D represent the selection of a “near linear” segment of curve for the preferred range of offset locking positions.

FIG. 14A is a spectral model of TF and FBG sensor offset to the minimum preferred offset in the Regime 1 calibration curve of FIG. 13.

FIG. 14B is a spectral model of the TF and FBG sensor offset to the maximum preferred offset in the Regime 1 calibration curve of FIG. 13.

FIG. 15 is a spectral model of output of a measurement system having a TF with 0.800 nm FSR RF employed with a strain gage having an FBG with 1.0 nm BW. With this combination of TF and FBG, even at mid-range attenuation, two sequential FFP peaks of the TF pass a significant portion of the FBG signal yielding very poor contrast in the measurement.

FIG. 16 is a plot of a calibration curve for a Regime 1 design with a 1.0 nm BW FBG sensor as in FIG. 15. Over the same +/−0.05 nm range, contrast using the 1.0 nm BW FBG is weaker than that of the ˜linear region of the same TF design with the 0.5 nm BW FBG (1.2:1 as compared to 3.8:1).

FIG. 17 is a spectral model of the output of a measurement system having a TF with FSR in the Regime 3 (80 nm FSR TF) range employed with an optical sensor having an FBG sensor (0.5 nm BW FBG) in Regime 3, where a peak of the transmission of the TF and the peak of the FBG output are set at an arbitrary offset.

FIG. 18 is a spectral model of the output of a measurement system having a TF with FSR in the Regime 2 (16 nm FSR TF) range employed with an optical sensor having an FBG sensor in the Regime 2 (0.5 nm FBG), where a peak of the transmission of the TF and the peak of the FBG output are offset locked at an arbitrary offset position.

FIG. 19 is a plot of a calibration curve for a system of Regime 2 design (a 16 nm FSR TF and 0.5 nm BW FBG sensor), showing two preferred ranges of operation.

FIG. 20 is a schematic drawing of an all fiber tunable Fabry-Perot filter useful in the measurement systems of this invention. The optical fiber of this filter is mounted into fiber ferrules and the etalon of the filter and a fiber gap within that etalon is created by mirrors formed on or within the ferrules. Such tunable FFP filters are known in the art and are commercially available. The illustrated FFP filter is tuned electromechanically by application of a voltage to a PZT actuator which changes the length of a fiber gap within the filter etalon to change the wavelength transmitted through the filter.

FIG. 21 illustrates the shape of the filter transmission output of a preferred all fiber tunable FFP which is particularly useful in the systems of this invention. The output of the all fiber tunable filter (e.g. as commercially available from Micron Optics) is compared to that of an alternative FP technology and the theoretical Airy function.

### DETAILED DESCRIPTION OF THE INVENTION

“Fiber Bragg Grating or FBG” refers to a periodic perturbation of the effective index of an optical fiber, yielding a narrow band reflection profile, the wavelength of which is sensitive to both temperature and strain. FBGs are used as sensing agents for both strain and temperature. FBGs (and optical sensors containing them) have a characteristic “Center Wavelength” which refers to the nominal peak reference wavelength of its reflection profile.

The term “optical sensor” refers generally to any class of optical component which reflects a specific narrowband optical spectrum that is affected by physical or environmental factors, such as strain, temperature, or other factors. Though the Fiber Bragg Grating is the most common and most obvious of such components, other components such as certain Fabry-Perot etalons can also function as optical sensors

Fiber optic sensors (also called optical fiber sensors) are fiber-based devices for sensing changes in some property in the sensor's environment. The property is typically temperature or mechanical strain, but can also be vibrations, pressure, acceleration, or concentrations of chemical species. The general principle of such devices is that the optical parameters of light from an optic source, often a laser or light emitting diode, introduced into such optical sensors can be changed, often subtly, due to the changes in the sensor's environment. The changes in optical parameters can occur simply due to the effect of the environment on the fiber of the optical sensor or on one or more in-fiber optical elements (e.g., Fiber Bragg Gratings). Often the changed parameter is a change in wavelength. An optical detector arrangement is employed to measures changes in the optical parameters and thereby measure changes in the sensor's environment (e.g., temperature or strain). Optical sensors preferred for use in this invention are those that comprise an FGB as the sensing element, i.e., in which changes in the center wavelength (embodied in the wavelength reflected from the FBG) intrinsically reflect changes in temperature or strain on the FBG. Such changes of strain or temperature can often be excited by other physical phenomena as dictated by an FBG based transducer. Such a transducer (often referred to as an “optical sensor” as well) can transfers changes in other phenomenon such as pressure or acceleration into one of the intrinsic sensing properties of the FBG: strain and temperature. In this context of this invention, the concept of optical sensor and FBG are used interchangeably, as the principle quantity for measurement is the optical center wavelength, regardless of how that parameter may relate to some higher level measurement via the sensor or transducer design.

An example of a fiber-based optical sensor containing an FBG is described in U.S. patent application publication US 2007-0193362A1, published Aug. 23, 2007. In this example, a fiber optical gage, comprising a fiber Bragg grating, is fastened to a metal carrier which is elastic with respect to expansion and compression along its longitudinal axis. The elastic carrier allows for variation of the distance between the two points at which the gage carrier is attached to a test specimen (DUT). This fiber-based optical sensor comprises an FBG and the metal carrier where the metal carrier contacts the object under test (e.g., DUT) and the FBG is subject to the elongations of the carrier due to strain upon the object under test. Through the physical properties of the carrier, the FBG reflection profile changes in response to dimensional changes in the object under test. In this example, the changes in wavelength of the optical sensor and the changes in strain of the object under test will differ by a constant, that is determined by the physical properties of the carrier in addition to the intrinsic strain/wavelength relationship of the FBG. As it pertains to the present invention, measurement of the change in FBG wavelength scales directly with change in the sensor strain measurement by that constant. As such, the terms “fiber-based optical sensor”, “strain sensor”, and “FBG” can be functionally interchanged, in reference to measurement of strain, as their measurement results would simply relate by said constant.

“Fiber Fabry-Perot Tunable Filter” (FFP-TF, FFP, or TF) refers to a specialized optical tunable filter based on Fabry-Perot etalon technology. The FFP tunable filters pass or transmit wavelengths that are equal to integer fractions of the cavity (etalon) length; all other wavelengths are attenuated according to the Airy function. Wavelength tuning is facilitated by changes to the etalon length, in preferred FFP tunable filters the etalon length is electromechanically tuned by applications of a voltage to a displacement actuator, in particular to a PZT actuator.

“PZT” refers to Lead Zirconate Titanate, a piezoelectric ceramic material that is commonly used in the design of displacement actuators.

“Free Spectral Range or FSR” refers to the frequency spacing of axial resonator modes of an optical resonator, such as an FFP. In FFP technology, the axial resonator modes are also known as “optical orders”.

“Bandwidth” refers here to the spectral width that can be transmitted through and optical component within defined limits of attenuation. Typically, a 3 dB bandwidth is quoted for FFP and FBG filters.

“Finesse or F” refers to the ratio of Free Spectral Range to the Bandwidth of a FFP filter.

“Ratiometric” refers to a method of measurement whereby a useful measurement quantity is derived not from the value of single metric, but rather by the ratio of a signal measurement to a reference measurement.

“Coupler” refers to an optical fiber device with one or more input fibers and one or several output fibers. Light from an input fiber can appear at one or more outputs, with a fractional intensity proportional to the optical coupling ratio. Couplers may be balanced providing equal intensity to each output or imbalanced in which the intensity at one or more outputs are not of equal intensity.

“Wavelength” refers to the distance between crests of a wave. The wavelength determines the nature of the various forms of radiant energy that comprise the electromagnetic spectrum. For electromagnetic waves, the wavelength in meters is computed by the speed of light divided by frequency (300,000,000/Hz).

“Broad Band Source” refers a class of optical sources which output and an optical spectrum spanning a wide range of wavelengths, generally 40 nm or more within the 1.5 pm wavelength range. Examples of these types of optical sources are Erbium doped fiber amplified spontaneous emission (ASE) sources, light emitting diodes (LEDs), and super luminescent light emitting diodes (SLEDs).

“Circulator” refers to a three port optical device with specific directionality of light transport on each of the ports. One side of the device has a single fiber that supports low loss transmission into and out of the component. The other side of the device has two fiber port, each of which supporting low loss transmission in a single, but opposite, direction from one another.

“Strain” refers the dimensional change in length of a body as normalized to its initial length. “Peak (or center) Wavelength” of an optical sensor refers to the nominal peak reference wavelength of its transmission or reflection profile. For purposes of the explanations here, “strain” and “peak (or center) wavelength” of the sensors relate by a simple constant. Determination of “peak (or center) wavelength” is functionally equivalent to determination of “strain.”

“ADCs” refer to Analog to Digital Converters, which are electrical components designed to convert analog input signals to digital output signals. A variety of ADCs is known in the art and can be used in the systems of this invention.

“DACs” refer the Digital to Analog Converters, which are electrical components designed to convert digital input signals to analog output signals. A variety of DACs is known in the art and can be used in the systems of this invention.

“Gauge factor” refers to a measure of the ratio of the relative change of optical wavelength to the relative change in length of an optical strain sensor

“Vibration Mode” refers to a periodic and repeated change in strain on a surface or in a material. In the explanation of the present invention, the term “Vibration Mode” assumes duration of oscillation in strain to be greater than a single acquisition cycle of the measurement system.

“Impact Event” refers to an instantaneous change in strain on the surface or in the material of a measurement object (e.g., DUT), often with duration shorter than that of an acquisition cycle of the measurement system. An “impact event” may actually trigger a “vibration mode” of the measured surface. The ability to discern the starting point of the event (particularly with regard to ability to trigger an acquisition correspondingly) characterizes an event as an “impact event.”

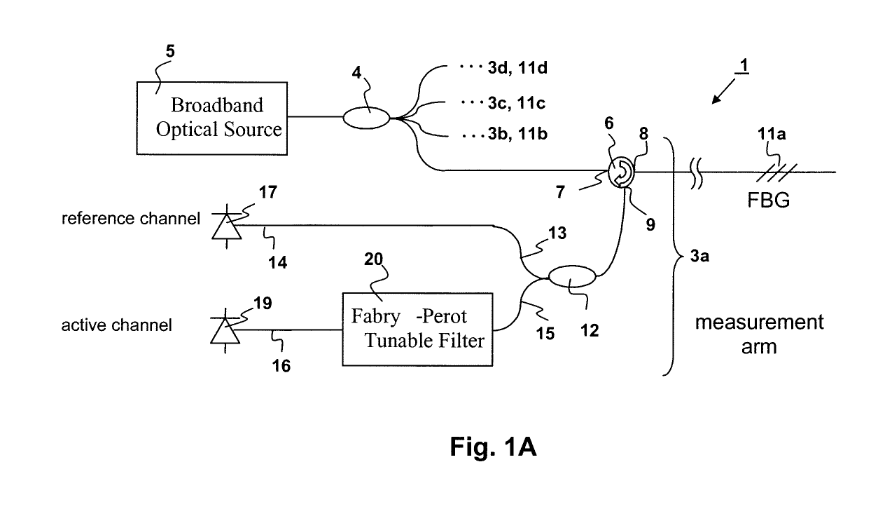

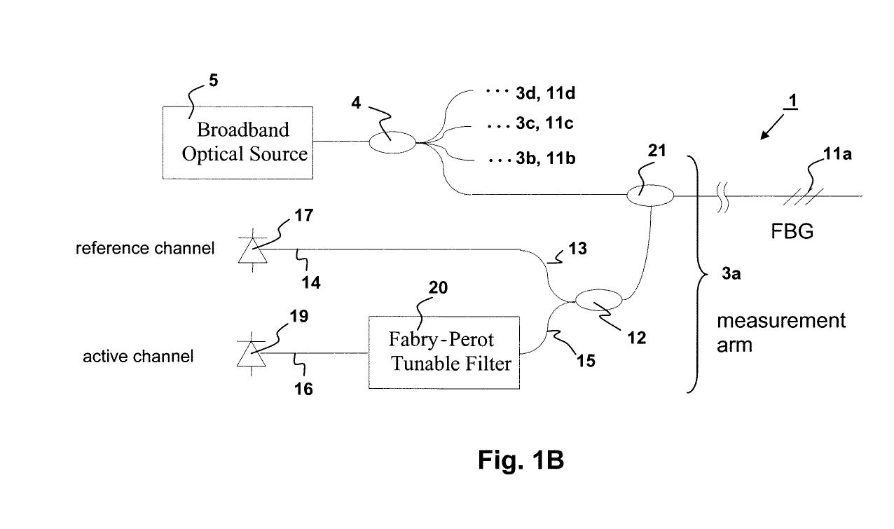

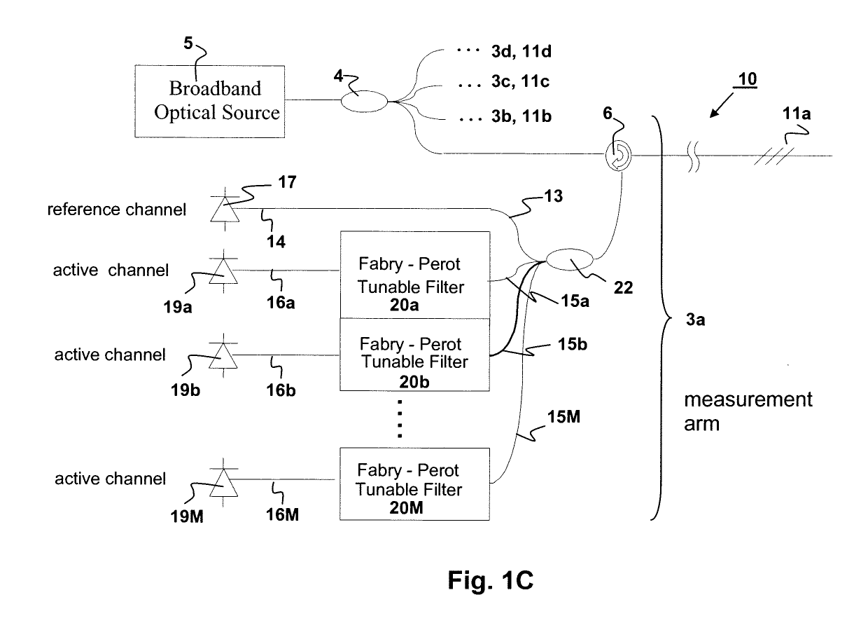

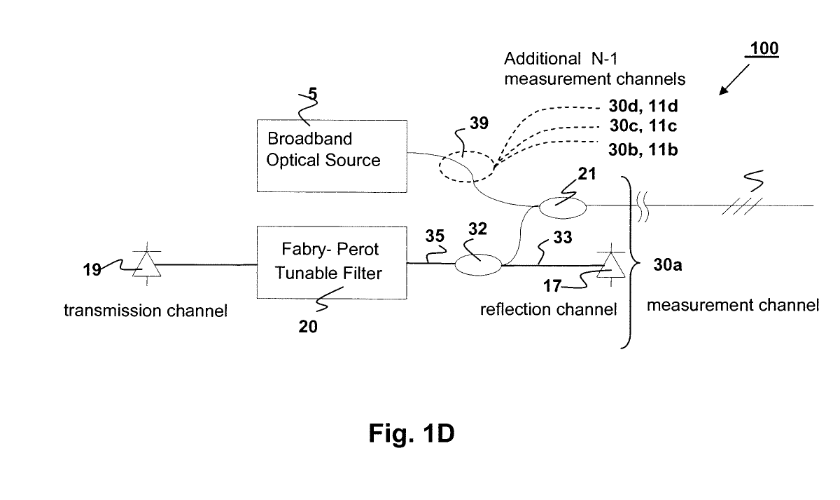

FIG. 1A illustrates an optical schematic of a high frequency sensor system (1) (FBG sensors in combination with a sensor interrogation system) of the present invention in a preferred embodiment. An optical broadband source (BBS, 5), such as an ASE source or SLED, emits a broad spectrum optical signal. That signal is split among a number (N) of parallel measurement channels (e.g., 3a) with a 1×N spectrally flat optical coupler (4) The resulting optical signal on each measurement channel (3a, 3b, 3c, 3d . . . 3N) path is identical to the original BBS spectral shape, only reduced in amplitude by a measure commensurate to the split ratio of the optical coupler. Along the optical path of each measurement channel, the BBS spectrum coupled into the single input port (7) of an optical circulator (6). The bi-directional propagation leg of the optical circulator (8) is coupled to an optical sensor comprising a Fiber Bragg Grating (11a) as the sensing element. As is understood in the art, care is taken with the FBG sensor to ensure that broadband reflections from the fiber (end faces, connectors, splices, etc.) are minimized and that the predominance of the reflected optical power from the sensor comes from the designed reflection profile (center wavelength) of the FBG sensor. The narrow band reflection spectrum from the FBG sensor (the center or reflected wavelength) is returned through the bi-direction propagation port (8) of the optical circulator (6) and exits that component via the single output port (9). The portion of the BBS light reflected by the FBG sensor is then optically split between two legs of an optical coupler (12), such as a 50/50% (balanced) or 80/20% (exemplary imbalanced) coupler. One output (13) of the coupler is directly connected to a reference channel (14) comprising a reference photodetector (17), for example a photodiode. The other output (15) of the coupler is coupled to an active channel (16) which comprises a Fabry-Perot tunable filter (20) followed by an active channel photodetector (19), for example a photodiode. Measurements of total integrated power are performed by both photodiodes, and the resulting ratio of measured powers between the two channels are calibrated and interpreted as dynamic wavelength change of the sensor (or FBG). Typically the data is viewed as a change in sensor wavelength as a function of time. The one or more optical sensors of this system may detect changes in temperature or strain. In a preferred embodiment of the device of FIG. 1A dynamic strain is measured. The one or more optical sensors of the systems of this invention or representative samples thereof are pre-calibrated with respect to center wavelength changes as a function or strain, temperature or both. This calibration information is employed to convert measured change in wavelength data to changes in temperature and/or strain.

FIG. 1B is an alternate embodiment of a sensor measurement system (1) of this invention in which the optical circulator is replaced with an optical coupler (21). A circulator is a preferred component, if preservation of optical power is an issue, due to a desire for source multiplexing or for maximizing loss budget. If optical power is not at issue, replacement of the circulator with an optical coupler offers a lower cost alternative.

FIG. 1C is another alternative embodiment of a sensor measurement system (10) of this invention, in which tunable filters are used in a plurality (more than one to M) of parallel active detection channels that form the active arm of the system, each active detection channel comprises an FP tunable filter and a photodetector, thereby facilitating simultaneous measurements of a single sensor at multiple wavelength ranges and sensitivity levels. In general the FP tunable filters of each active detection arm of the active arm are selected (as described herein below) to facilitate measurement of sensor output over different wavelength ranges and/or sensitivity levels. In the illustrated implementation, the single 1×2 coupler of FIG. 1A is replaced by a 1×(M+1) coupler (22), with M equaling the number of detection channels in the active arm. A single reference arm can be used with all of the parallel active detection channels in the system of FIG. 1C. Each tunable filter can be independently controlled to maintain a selected offset point, as described in detail below.

For the systems of FIGS. 1A-1C only one measurement channel is described in detail. As discussed above each system can be implemented for detection of N sensors and have N measurement channels.

FIG. 1D is another alternative embodiment of a measurement system of the present invention, in which both the transmitted and reflected signal from the FFP are used to determine the wavelength offset position of the FFP relative to the FBG sensor center wavelength. Because the reflection and transmission properties of an FP filter are complimentary, the ratio of these two signals is intrinsically self-referencing for any fluctuations in the power of the reflected output of the FBG. The system of FIG. 1D (100) has one sensor (11a) with one measurement arm (30a) having a reflection channel (33) and a transmission channel (35). Output of the BBS (5) is optically coupled through coupler (32) to the optical sensor (FBG, 11a) and light reflected from the FBG is coupled into a measurement arm (30a) via a measurement arm optical coupler (32). This optical coupler directs reflected light from the sensor into TF (20). Light transmitted through the TF is coupled to transmission channel photodetector (19) and light reflected from the TF is coupled into the reflection channel photodetector (17).

The system illustrated in FIG. 1D can be implemented for measurement of N sensors (11a . . . 11N) by introduction of a 1×N coupler (39) following the BBS (5) which allows optical connection to N sensors and their accompanying N measurement arms.

The invention also provides sensor systems comprising one or more optical sensors optically and a sensor interrogation system of this invention in which each of the one or more optical sensors are optically coupled to a measurement arm of the sensor interrogation system. Preferred sensor systems are those used for detection of strain, particularly high frequency changes in strain in an object under test. In general any fiber-based optical sensor can be used in such sensor systems. Preferred optical sensors in such systems are optical strain sensors and more preferred optical sensors are those containing FBGs. In specific embodiments, the invention provides systems for high frequency measurement of strain in an object under test employing an interrogation system of this invention and fiber-based optical sensors containing FBGs as described in U.S. patent application publication US 2007-0193362A1, published Aug. 23, 2007.

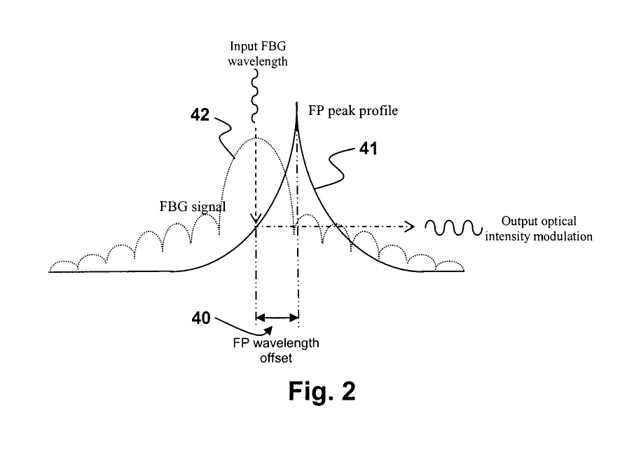

FIG. 2 illustrates the optical interaction between the Fiber Bragg Grating mounted on a DUT and the Fabry-Perot measurement optics of the measurement systems of this invention. During a measurement, a peak of the Fabry-Perot filter Airy transmission profile (41) is intentionally wavelength offset (40) from the FBG resonance wavelength (42) such that the peak of the FBG sensor output falls on a side slope of a peak of the FP filter transmission. As the FBG's reflection profile is connected serially with the TF transmission profile, the attenuation of the FBG signal is directly affected by the extent of offset between the wavelengths of the FBG and FP filters. Once offset tuned as described above, any change in the wavelength of the FBG resonance peak as related to the FP filter peak will result in a change in the total integrated power of the signal at the output of the FP filter. Due to the large attenuation slopes afforded by Fabry-Perot filters, the change in total integrated output power per change in FBG resonance frequency can be made to be very high. Additionally, due to the extremely smooth, ripple-free transmission profiles afforded by the FP filters, any changes in total integrated power can be attributed to the change in resonance alignment between the two components and not attributed to noise or ripple in the filter response. FIG. 2 illustrates how a small modulation in the FBG resonance wavelength relative to the FP resonance wavelength results in a large amplitude modulation of the total integrated power emerging from the two components.

A linear change in the offset of the wavelengths of the FBG and FP components results in a non-linear change in the total integrated power emerging from the two components. A calibration is needed to characterize the non-linear relationship between resonance wavelength offset and total integrated power, as well as the application of the non-linear calibration data to raw collected data in the generation of calibrated AC wavelength change data.

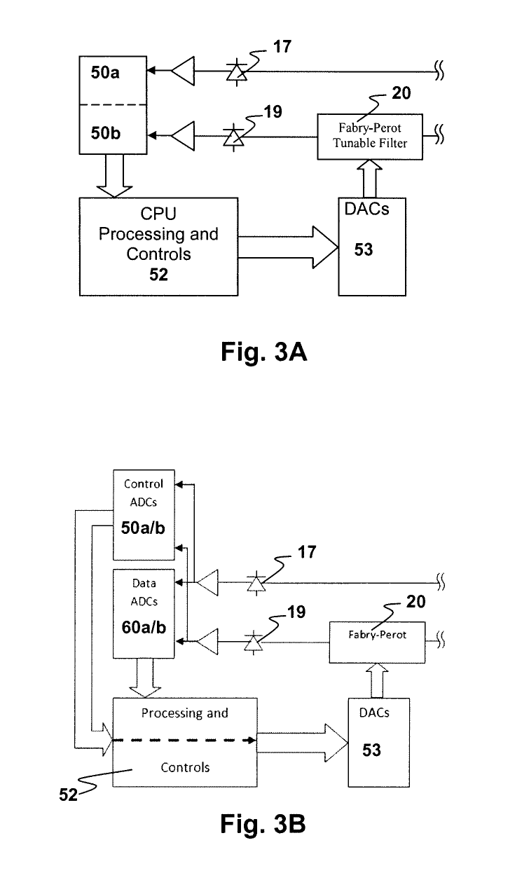

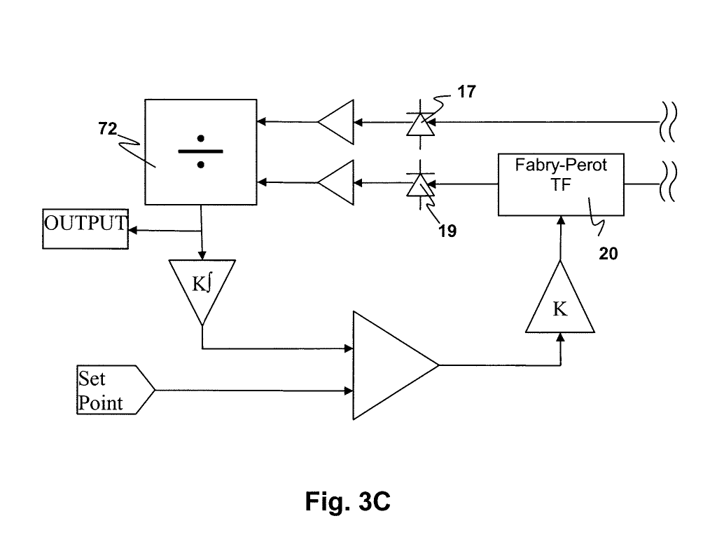

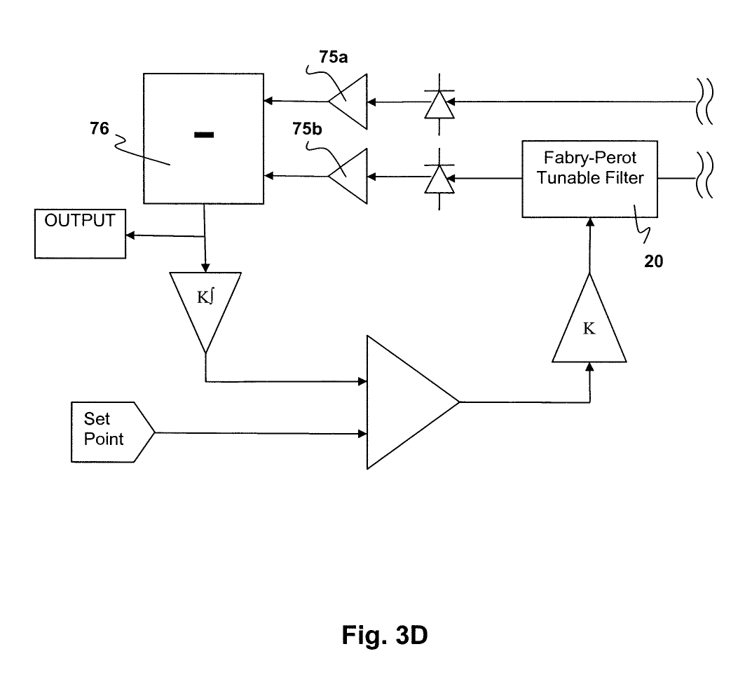

FIG. 3A shows a block diagram of an embodiment of an electronic data acquisition and electronic control system that interfaces the optics of measurement systems of this invention, such as those in FIGS. 1A-1D. Two ADCs (50a and 50b) convert the analog signals from the photodiodes (e.g., 17 and 19, respectively as in FIG. 1A). The digital readings of total integrated power are manipulated by the processor (52), utilizing calibration data stored in the processor relating the ratio total integrated power between the active and reference channels of the measurement system to dynamic wavelength. The DC component of the power ratio change is evaluated by the CPU (52) and used to provide bias feedback to the TF (20) via the DACs (53). This bias feedback is used to maintain the selected offset of the wavelengths of the TF and FBG.

FIG. 3B shows a block diagram of an alternate embodiment of an electronic data acquisition and electronic control system, where the addition of a second set of ADCs (60a and 60b) allows for asynchronous conversion of the second set of ADCs so that TF bias feedback can be provided at any arbitrary rate, independent of the conversion requirements of the data acquisition loop. Here, the control ADCs convert the signals from the reference and active channels (17 and 19, respectively) and pass a block of collected data to the processor (52). The processor then evaluates the mean of the data block (mean wavelength) for use in biasing the TF. In this implementation, the conversion rate and number of samples for the control and data ADCs can be made independent of one another, such that TF control can run at one selected rate and data collection for evaluation can run at another selected rate. TF offset wavelength control will typically be run at a rate that is much lower than that of data collection.

FIG. 3C is a block diagram of an alternate embodiment of an electronic data acquisition and electronic control system. The illustrated system is an analog, closed-loop, electronic servo control system that calculates the ratio of total integrated optical power (from reference channel) to the wavelength dependent attenuated optical power (from active channel). The output of the divider (72) represents the DUT wavelength. To maintain calibration the output of the divider is scaled, averaged and compared to a calibration set-point level. The difference amplifier output (error signal) is scaled, buffered and used to control the tunable filter.

FIG. 3D is a block diagram of an alternate embodiment of an electronic data acquisition and electronic control system which is an analog, closed-loop, electronic servo control system that uses logarithmic amplifiers (75a, 75b) to calculate the ratio of total integrated optical power to the wavelength dependent attenuated optical power by simple subtraction (76).

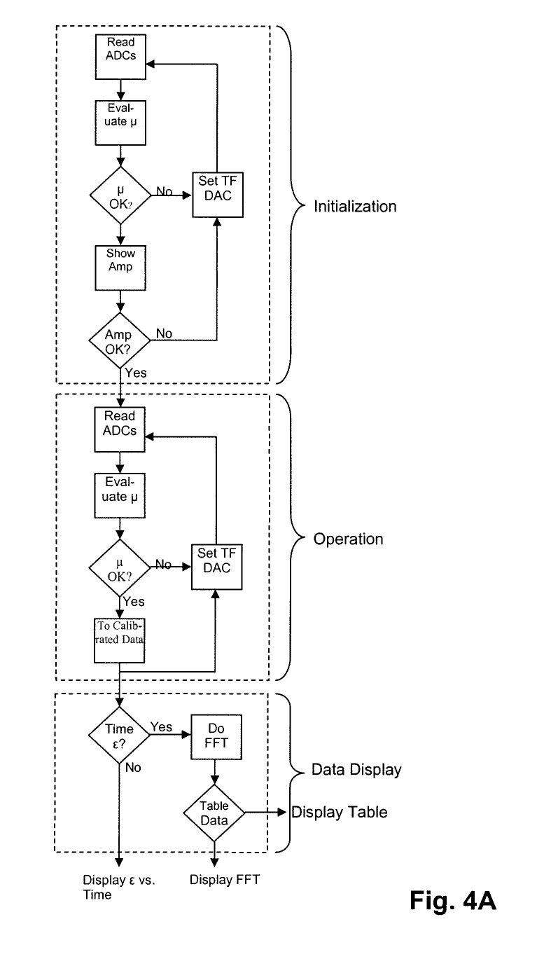

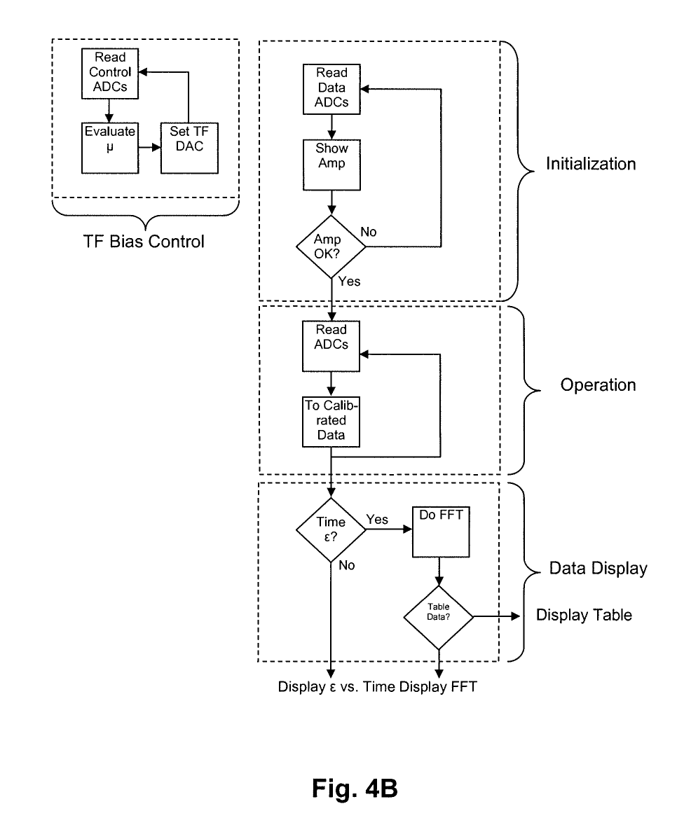

FIG. 4A shows the software flowchart for an implementation of the measurement system of the invention as shown in FIG. 1A. The order of operations in the flowchart comprises initialization, operation and data display as follows:

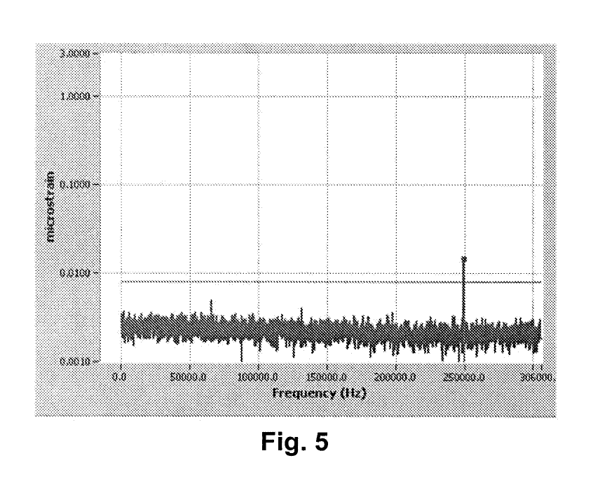

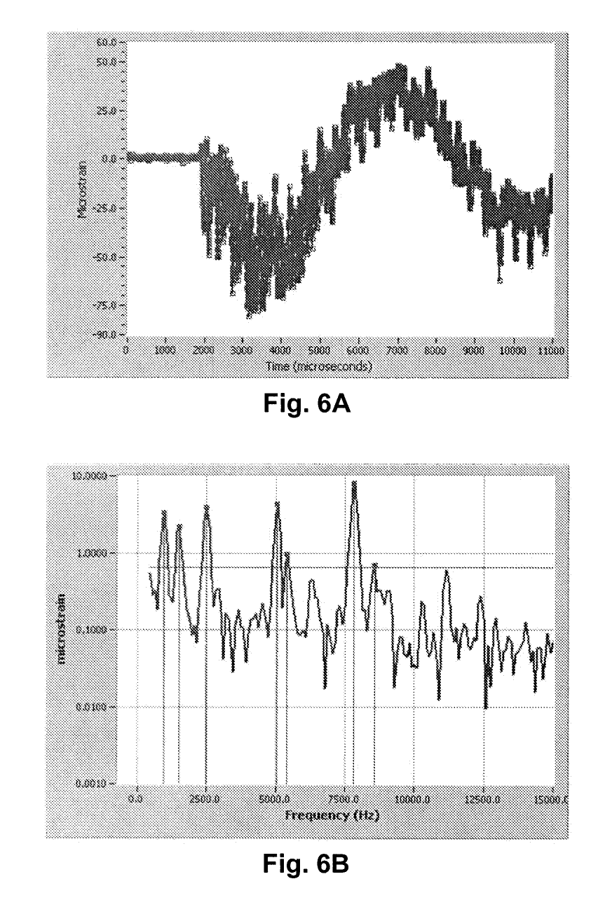

First, an initialization sequence occurs. The two ADCs for particular reference and active channels are read. The number of data points acquired and the rate of acquisition directly dictate the frequency content of the signals that can be evaluated by the system. Commercially available ADCs enable data acquisition at rates anywhere from DC to several billion samples/second. In the examples of FIGS. 5, and 6A-6C, data acquisition rates of ˜600,000 are used enabling measurements of sensor activity up to −300 kHz. The limitations of acquisition speed are dictated principally by the available A/D resources, receiver bandwidth, and data processing speeds. No elements of the optical configuration of the measurement systems of the present invention impart any limits on the rate at which sensor data can be acquired and processed.

An evaluation of the mean power ratio of the collected data is made and compared against a set of predefined limits. These limits are used to evaluate whether or not the TF is biased to the selected offset position, relative to the FBG sensor coupled to the TF. If the TF is not biased within the selected offset range, a modified voltage is sent via the DAC to the TF (e.g., to the displacement actuator of the TF) to tune the power ratio into range. The ADCs are immediately read again. This loop continues until the power ratio does fall into the selected range. Next, the amplitude of the reference channel signal is evaluated, either by user interaction or in an automated, programmatic fashion. Either way, the amplitude is either deemed to be acceptable or unacceptable. If the amplitude is found to be unacceptable, then the error signal generated by the previous evaluation of the mean is used to send a modified voltage to the TF and the loop begins again. If, however, the amplitude is found to be acceptable, then the initialization sequence is complete and the application progresses towards the operation phase.

In the operation phase, as in the initialization sequence, the first step is the collection of data from the ADCs. Again, the data is first evaluated for the mean value of the power ratio between active and reference arms and compared against predefined limits. If the mean value is not within the selected limits, the TF is immediately re-biased via the DAC, the collected data is discarded and the next acquisition takes place. If the mean value is within selected limits, then the determination is made that the collected data is valid and can be converted by the processor into calibrated data. As the raw data is converted to calibrated data, any difference between the measured mean ratio and the target mean ratio is evaluated and used to apply a correction voltage to the TF via the DAC. In this way, the offset of the TF filter is always under active bias control. The predefine limits are simply used to block data from the user, should the TF stray too far from the region over which the TF profile has been calibrated. In a particularly preferred implementation, closed loop control maintains the power ratio within a selected range, and all collected data can be deemed valid.

The closed loop operation of the tunable filter serves to prevent calibration drift in the system due to low frequency variations in the sensor's center wavelength. These low frequency variations can be due to thermal fluctuations in the sensor measurement environment or other low frequency phenomena that would affect the sensor wavelength, such as slow strain changes. The frequency at which the system can compensate for drift affects the minimum frequency AC component of wavelength change that can be measured. These two frequencies are directly related, and are dictated by the acquisition rate of the system, the period of acquisition, and the repetition rate of acquisition. Referring to the implementation of FIG. 4A, the rate of feedback to the TF via the DAC is limited by the rate at which data is collected and the mean is evaluated. If data is collected and transferred in large blocks to facilitate a desired measurement time window for the sensor, then the TF bias feedback loop would be bound to the same timeframe. An alternate implementation for TF bias feedback control is shown in FIG. 4B.

With reference to FIG. 3B, the second set of ADCs, labeled Control ADCs 960a and 60b), allows for all mean evaluation and setting of DACs for TF control to be implemented in a separate loop. As described before, this method allows for continuous, asynchronous control of the TF bias, completely independent from the data acquisition, processing, and display loop.

With current practical limitations (electronic noise, PZT capacitance, processing speed, etc.) a control loop can be established to maintain offset locking with a low frequency oscillation as high as about 100 Hz. Theoretically, it should be possible to control that loop with a feedback loop operating at only 200 Hz, though a robust ratio to track drift or low frequency oscillations of appreciable slew rate would suggest operating the feedback loop at about 1 kHz. Thus, if, for example, the system is running closed loop at 1 kHz, it could track and maintain constant offset of the wavelength of the TF from that of the FBG sensor for all signals at 100 Hz or less. The TF would then be effectively AC coupled to the FBG sensor, tracking and nullifying all oscillations of 100 Hz or less (and thereby maintaining calibration for the high frequency measurements) and measuring accurately all signals greater than the feedback frequency of 1 kHz. These numbers represent a maximum practical feedback rate and could be scaled downward. For example, a 100 Hz feedback frequency would allow the system to robustly track low frequency drift or oscillations at a rate of 10 Hz or less, while facilitating accurate measurements on signals greater than 100 Hz. In this example, “low frequency” would be defined as 10 Hz or less, while “high frequency” would be defined as 100 Hz or more. In another example, a 10 Hz feedback frequency would allow a system to robustly track low frequency drift or oscillations at a rate of 1 Hz or less, while facilitating accurate measurements on signals greater than 10 Hz. In this example, “low frequency” would be defined as 1 Hz or less, while “high frequency” would be defined as 10 Hz or more.

Finally, both FIGS. 4A and 4B show a data display section, where the acquired and calibrated data are presented as time varying strain or processed as frequency content in graphical or tabular form.

FIG. 5 is a plot of the resultant measurement data from a measurement system of this invention using a vibration mode analysis, demonstrating the frequency response and sensitivity of the measurement system. In this example implementation of the invention, the data acquisition is running at a rate of 600k samples/second, enabling the characterization of vibrations in the optical strain sensor at rates of up to 300 KHz. FIG. 5 shows a clearly defined vibration mode on the optical strain sensor at ˜250 kHz, with a total RMS strain of about 0.02 με.

FIG. 6A is a plot of the time varying strain signal of an impact event on a body (DUT) instrumented with an optical strain gage (having an FBG sensing element, as measured by a high speed strain measurement system of this invention. At time zero (0), there is no strain of note on the sensor, and the tunable filter has been biased to its selected operating wavelength offset from that of the FBG sensor. When the sensor is struck, the wavelength of the sensor begins to oscillate at a plurality of frequencies. FIG. 6A shows a time varying plot of the superposition of these resonant frequencies of the sensor on its substrate. It can be seen that the vibrations are periodic and oscillate about the original zero strain level of the sensor prior to impact.

FIG. 6B is a plot of the frequency domain spectrum of the impact event of FIG. 6A, with the X axis scaled to show detail in the 0 to 20,000 Hz range. Several strong frequency modes are marked by peak detection indicator dots.

FIG. 6C is a plot of the frequency domain spectrum of the impact event of FIG. 6A, with the X axis scaled to full, to show full frequency response of the measurement system. It can be seen that there are several resonant modes of the vibrating substrate above the 50 KHz range, including modes at ˜65 kHz, ˜110 kHz, and ˜175 kHz. All of the modes are clearly detected by the measurement system of the present invention, despite the RMS strain at each mode being less than 1 με.

FFP Filters:

All-fiber Fabry Perot tunable filters are particularly useful in the devices and methods of this invention. Of particular use are FFP-TF which are tuned electromechanically using a displacement actuator, such as a PZT. FFP-TF in which piezoelectric transducers are employed for tuning allow for precision offset locking and rapid voltage driven feedback to maintain maximum strain sensitivity of measurements. The use of FFP tunable filters exhibiting smoothness of transmission profile (see FIG. 22) allow for highly sensitive high speed strain detection. Preferred FFP tunable filters exhibit minimal or no ripple on the transmission profile. The presence of ripple can severely limit sensitivity of the measurement system. FFP tunable filters which show adherence to the theoretical Airy profile allow for total integrated power measurements (via the offset locking technique described herein) to be calibrated to known wavelength, and via the gauge factor, strain values in the measured sensor.

In contrast to a tunable FFP, a fixed FFP can only measure sensors within very specific wavelength ranges. Thermally tuned FFPs have limited use because they can not always be tuned far enough to track the entire wavelength range preferred for a useful measurement. The use of a voltage tuned filter (e.g., using a displacement actuator PZT) allows for the use of sensors at any wavelength within the range of the BBS. The ratio of total integrated power from the two or more channels (e.g., one reference and one or more active) on each measurement arm of a measurement system is used both as the measurement signal of dynamic wavelength strain and as the feedback signal to offset lock the FP wavelength from that of the FBG sensor. The voltage tuning of the piezo-tuned FFP allows the filter to remain offset locked from the FBG at a selected delta frequency preferred for maximum measurement sensitivity, thereby eliminating the detrimental effects from FFP or FBG slow wavelength changes, be they thermal or otherwise.

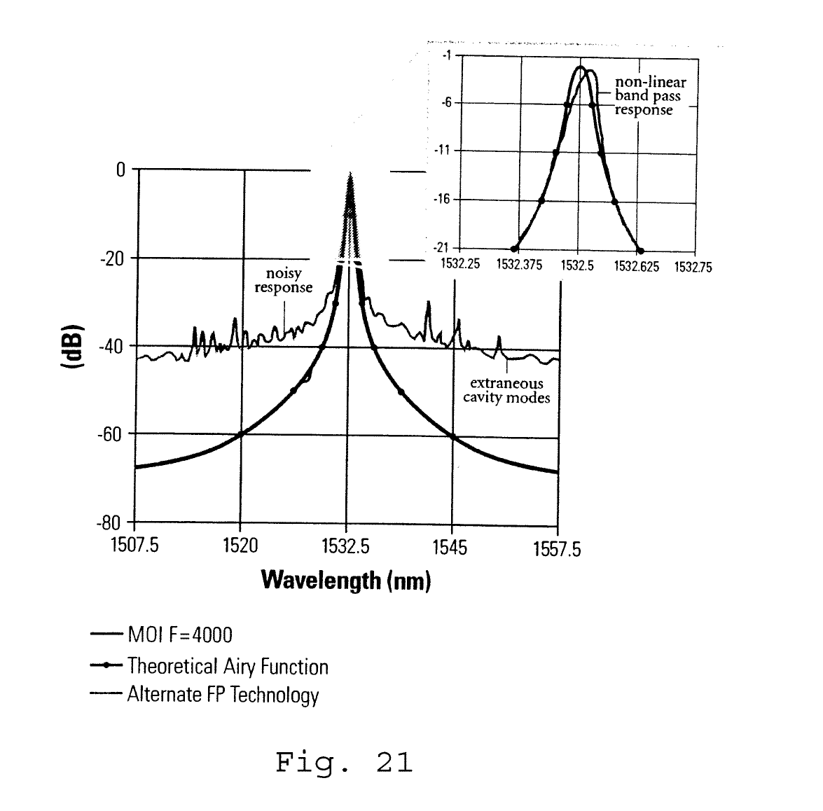

Fiber Fabry Perot filters are well-known in the art and commercially available. Tunable FFP filter that are particularly useful in the present invention can be obtained commercially from Micron Optics, Inc. (Atlanta, Ga.). An example all fiber FP tunable filter is illustrated in FIG. 20 and a description of such filters is available at www.micronoptics.com. One or more of the following patents or patent applications can provide details of FFP tunable filters and optical sensors useful in this invention: U.S. Pat. Nos. 7,063,466; 6,904,206; 5,838,437; 5,289,552; 5,212,745; 6, 241,397; 5,375,181; 6,504,616; 5,212,746; 5,892,582; 6,115,122; 6,327,036; 5,422,970; 5,509,093; 5,563,973 and U.S. patent application Ser. No. 11/452,094 filed Jun. 12, 2006. Each of these patents or patent applications is incorporated by reference herein in its entirety to provide a description of FFP filters useful in this invention.

These FFPs have optical fiber inside the etalon which guides the light with each bounce between the mirrors. The FFPs are preferably implemented employing fiber ferrule which carry the optical fiber. The etalon of the filter is formed between mirrors positioned on or between fiber ends at ferrule end faces. The FFPs do not exhibit the extreme alignment, temperature, and vibration sensitivities of bulk-optic Fabry-Perot interferometers. The alignment sensitivity of this all fiber FFP technology is no greater than that of an individual single-mode optical fiber splice or connector. This FFP Technology has natural fiber connection compatibility unlike lenses or integrated waveguides, which encounter fundamental connection difficulties. In specific embodiments, this all fiber FFP technology is combined with high resolution mechanical positioning devices, and preferably with Piezoelectric Transducers (or actuators, PZTs), to position the etalon mirrors. PZTs are used in atomic force microscopes to position elements to subatomic dimensions. This level of mechanical resolution ensures stable, smooth, repeatable tuning of any tunable FFP filter. These three properties allow the all fiber FFPs optical response to truly follow the Airy function from the top of its low-loss peak down to the very bottom of its stop band, and to be smoothly and precisely controlled over all points in between.

The shape of any filter response defines its performance characteristics (see FIG. 21). The high degree to which the all fiber FFP Technology particularly that available commercially from Micron Optics follows the Airy Function theory means that optical systems can be designed to exhibit extremely low loss, predictable cross-talk, highly accurate power measurements, high Optical Signal to Noise Ratio (OSNR), and excellent wavelength resolution.

All fiber FFP tunable filters show distinct advantages including excellent transmission power linearity and isolation characteristics again as shown in FIG. 21. All fiber FFP tunable filters provide high resolution, deep dynamic range and continuous, smooth and true tuning over a wide temperature range (0 to 65° C.)

Selection of Preferred Optical Components

I. Basic Theory of Operation—Spectral Domain

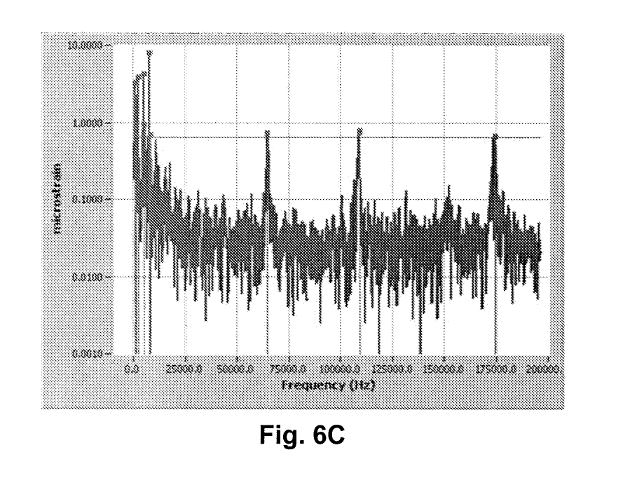

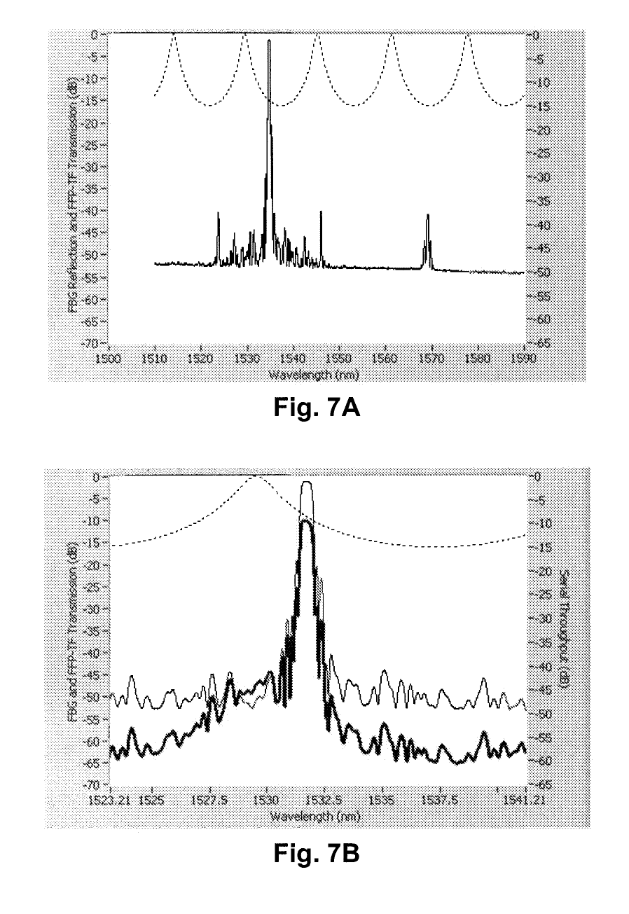

This section refers to FIGS. 7A-19. Several of these figures illustrate “Spectral models”. These figures show modeled results of the optical circuit in the spectral domain of an exemplary embodiment of a measurement system of the present invention. In each of these figures, there are either two or three spectral features of note. In all such Figures there is a thin, dashed-line trace that corresponds to the FFP-TF spectral transmission profile, and a thin, solid line trace that corresponds to the reflected spectral profile of a sensor FBG. Both of these traces are mapped to the Y axis on the left side of the trace, labeled “FBG Reflection and FFP-TF Transmission (dB).” On the remaining “Spectral Model” plots of the Figures, there is an additional spectral feature mapped to the Y axis on the right and labeled “Serial Throughput (dB)”. This trace (a thick solid line) shows a modeled spectral power distribution of the FBG's reflection profile as transmitted through the attenuation profile of the FFP-TF. As discussed in more detail below, the degree of attenuation depends upon the spectral mis-alignment (i.e. wavelength offset) of the two components, referred to in the application as the degree of “offset” that defines the “offset locking”, that is employed in the measurement systems of the present invention.

FIG. 7A illustrates the basic operation of systems of this invention. An optical sensor, such as an FBG, which is sensitive to strain, temperature or both, is used to reflect light from a broadband source, and that reflection is passed through a Fabry-Perot filter, whose characteristic transmission profile is used to convert high-speed wavelength variation into amplitude variations. As can be seen in FIG. 7A, there may be several FP orders that resonate within wavelength range of the broad band source. Any one of the FP modes can be tuned for offset locking to any wavelength within the wavelength range of the broad band source.

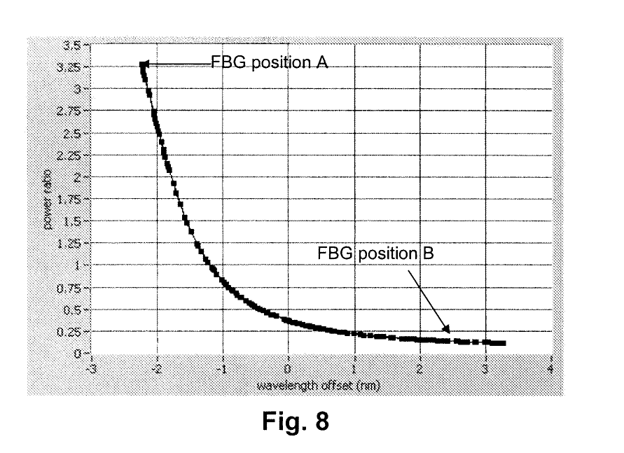

FIG. 7B shows a zoomed view of the interaction of the FBG signal and the FFP-TF transmission of FIG. 7A, with the resultant throughput spectrum denoted by the thick solid line. Varying the wavelength offset between the FP peak and the FBG peak generates a varying degree of attenuation on the resultant signal trace (thick solid line). All of the optical power under the thick solid line is integrated into the active channel photodetector. All of the optical power under the thin solid line is integrated into the reference channel photodetector. The ratio of those two power measurements is what defines the “power ratio”, to which all calibrations and operating conditions are referenced. By varying the wavelength offset between the two signals and recording this power ratio, a calibration curve like that of FIG. 8 is generated.

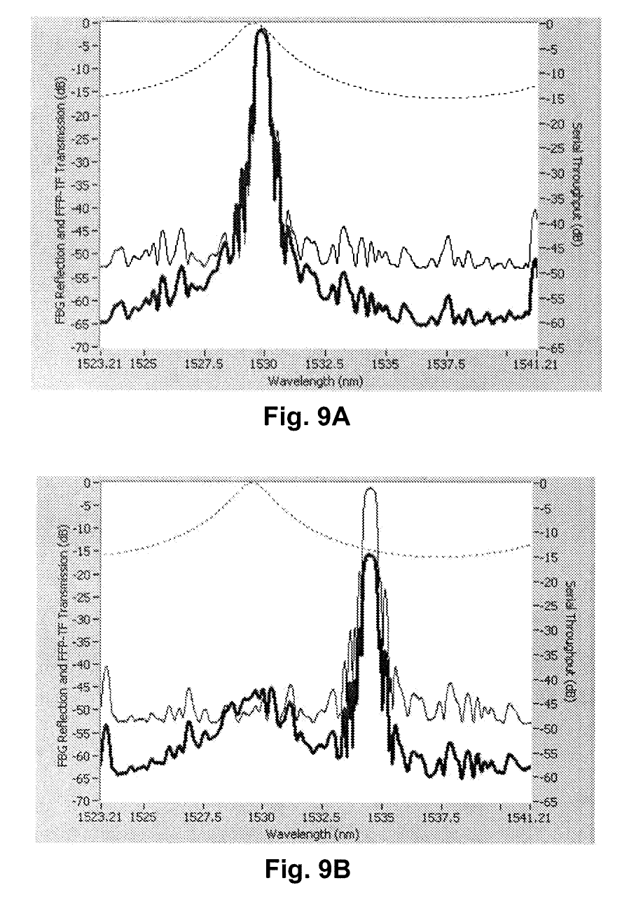

FIG. 8 shows the variation in the ratio of active channel power to reference channel power as a function of wavelength offset from an arbitrary starting point offset. Two annotated calibration points, labeled “FBG position A” and “FBG position B” correspond to the spectral models of FIGS. 9A and 9B, respectively. At FBG position A, FIG. 9A shows that the TF and FBG wavelength resonances are at near perfect alignment. As such, the power transmitted through the FP is at a near maximum, and thus, so is the ratio of active channel to reference channel power, as seen in FIG. 8. At FBG position B, FIG. 9B shows that the TF and FBG resonances are largely misaligned or offset. As such the power transmitted through the FP is significantly lower than in position A, and thus, so is the ratio of active channel power to reference channel power.

The curve of FIG. 8 can be used to point out several practical concerns and considerations that factor into the selection of components for preferred embodiments of the invention.

1. Should the offset lock position be biased towards position B, there is not a significant enough change in power ratio for a unit change in wavelength to be of practical use. It is noted that this portion of this curve does not provide for a useful measurement range.

2. Should the offset lock position be biased towards position A, the total integrated power received on the active channel can increase dramatically as the wavelength changes. In order to balance an appreciable range of wavelength measurements with the resolution considerations raised above in point 1, it is necessary to manage active channel signal levels to prevent detector saturation. This can be accomplished by appropriate selection of couplers.

3. It is also noted that the curve of FIG. 8 is highly non-linear. Taken in total, there would be a large degree of variation in measurement resolution.

4. Another design consideration is the choice of sensor FBG bandwidth. A goal of one preferred embodiment of the invention is to facilitate a useful array of measurement ranges using sensors of the same design and/or specification. Choice of FBG sensor specifications is discussed below.

The foregoing problems can be solved as follows:

1. To maximize the optical power budget, the coupler ratio of the coupler which directs light into the reference channel and the one or more active channels is selected to maximize return power to reference arm. The goal of this selection is to maximize loss budget while preventing active channel saturation over the device operating range.

2. To mitigate the concern of item 3 above, preferred embodiments of the systems herein operate on a small percentage of total tunable filter profile . . . ˜5-10% of the FSR. This yields a more acceptably linear operating range, providing more consistent measurement resolution, as well as a limit in the total power variation to simultaneously allow measurement signal to noise to be maximized and yet also prevent detector saturation.

II. Three Exemplary Regimes of System Operation

In preferred embodiments the invention is intended to facilitate measurements over a variety of strain ranges, as a continuum is not practical. The following describes optimization of a measurement system of this invention for three operation regimes (I-III), which were selected based upon measurement market need. The three operating regimes are: +/−50 pm (I), +/−500 pm (II), and +/−5000 pm (III).

A. List of Design Considerations:

1. Maximize strain range for each regime (requires consideration of TF FSR and finesse, FBG bandwidth, and optical coupler choice to balance reference and active detection arms);

2. Maintain relative measurement dynamic range among measurement regimes (requires consideration TF FSR and finesse);

3. Maximized TF transmission linearity (requires consideration of TF FSR and finesse, FBG bandwidth); and

4. Ensure ability to close filter loop (requires consideration TF FSR and finesse) for AC coupling and drift tracking.

B. Design Choices Common to All Three Regimes.

Tunable Filter. The preferred TF finesse is in the range of 10, +/−˜20%. A lower finesse offers too little contrast; wavelength changes do not manifest as a large enough insertion loss change. Higher finesse results in the approximately linear range comprising too small a fraction of total free spectral range. This limits strain range excessively and makes closed loop operation impractical, any reasonable error signal applied to filter will manifest as significant noise on the data signal.

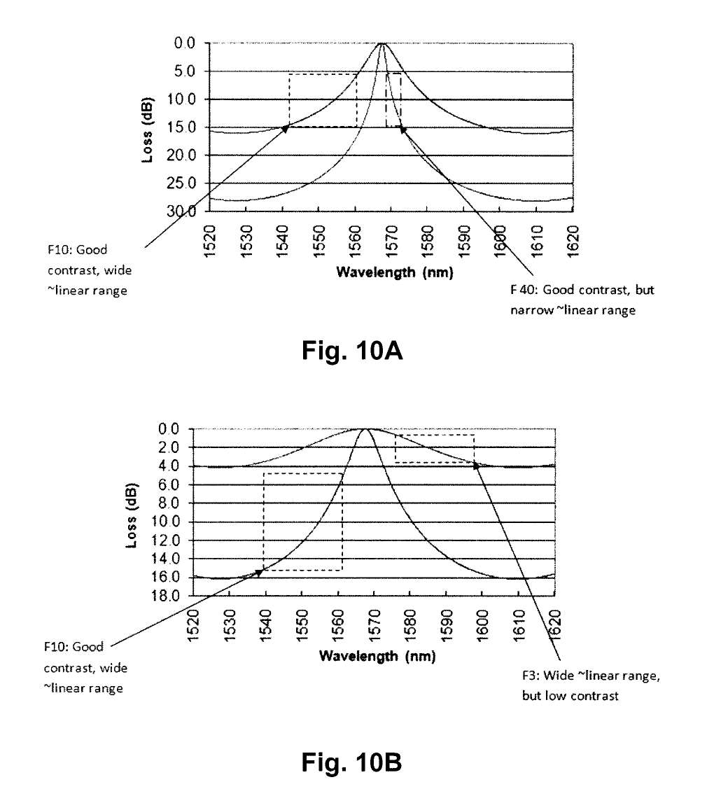

FIGS. 10A and 10B illustrate the process of selecting TF finesse for the systems of this invention. The top curve of FIG. 10A shows the transmission profile of a finesse 10 curve. Note that over a given design-goal wavelength range (˜20 nm in this example), the tunable filter offers good contrast of ˜10 dB, enabling rapid and accurate conversions by the ADCs to represent the sensor wavelength changes. Compare this feature to the finesse 40 curve, lower curve in FIG. 10A. For a similar contrast of 10 dB, the measurement range of the F40 is less than 5 nm. Clearly, here finesse of 10 is the preferred choice.

FIG. 10B shows the negative implications of a choice of finesse appreciably less than 10. Here, the finesse 10 curve is represented by the trace on the bottom. Again, the dashed block indicates that for the design range of −20 nm, there is a good 10 dB contrast. Compare that to the contrast of the finesse 3 curve at the top. For the same ˜20 nm range, the finesse 3 curve would only provide contrast of 3.5 dB or so. This type of contrast is insufficient for translating wavelength variations to amplitude variations of any useful degree of resolution.

In one preferred embodiments a single sensor design is employed for ease of use. It would be increase versatility of a sensor measurement system if a user was not required to employ a unique FBG grating design for each specific measurement range. To facilitate a system which can be sued with a common FBG bandwidth and reflectivity, TF and optical coupler properties are matched to maximize loss budget and measurement signal to noise, while preventing reference or active channel photodetector saturation. The rationale for the selected FBG bandwidth in such a system embodiment will be explained in the specifics of the three example measurement regimes.

C. Specifics of System Component Choices for the Three Exemplary Measurement Regimes.

Regime 1—Measurement range of +/−50 pm.

TF selection: F=10. FSR=0.8 nm;

FBG bandwidth=0.5 nm;

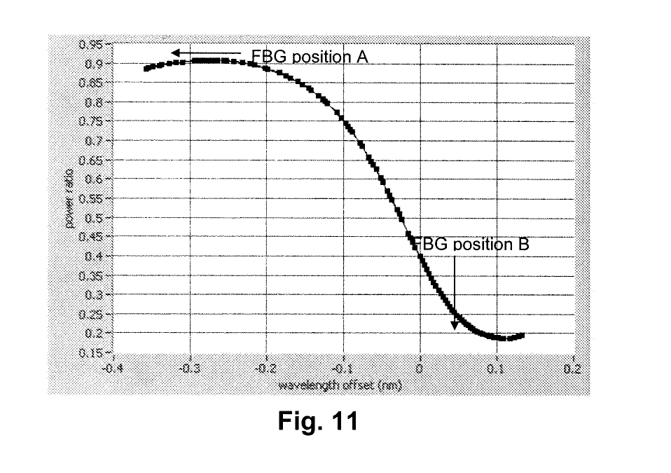

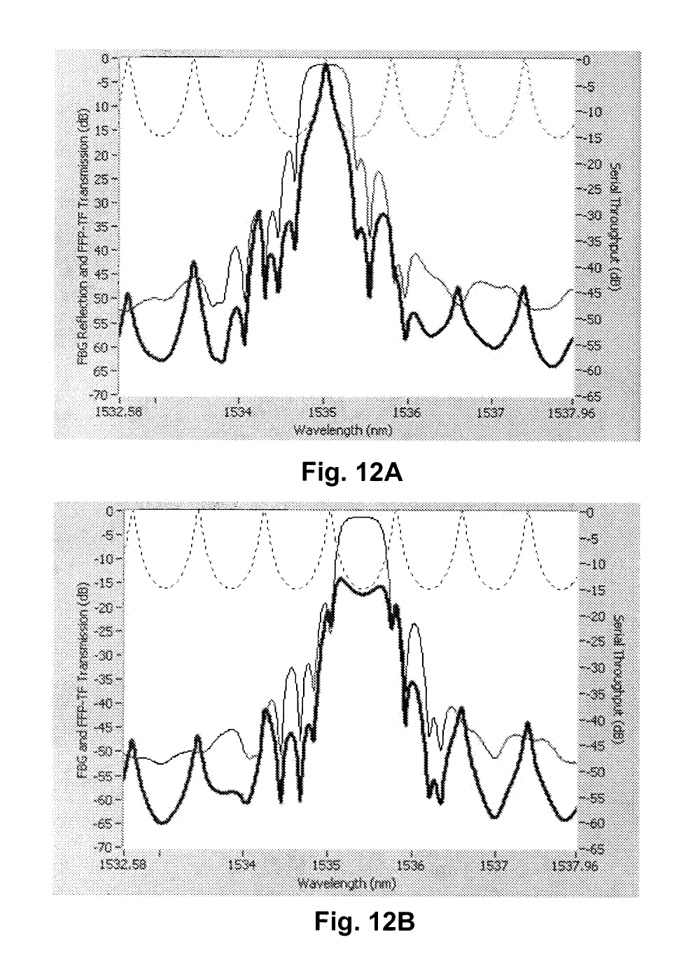

In this exemplary system, the FBG BW and TF FSR are nearly equal. FIG. 11 shows the calibration curve of power ratio versus wavelength offset from an arbitrary starting offset, in nm for the selections above. Two annotated calibration points, labeled “FBG position A” and “FBG position B” correspond to the spectral models of FIGS. 12A and 12B, respectively. In position A, it can be seen that the TF and FBG profiles are nearly aligned; any additional offset causes the curve to reverse direction, leading to an ambiguity in the calibration curve. The same is true at position B, where the FBG is aligned to the null between two successive FP peaks.

The measurements of Regime 1 highlights that the measurement systems of the invention operate on the basis of total integrated power, rather than peak power, as the peak powers are highly unrelated to the results, as seen in FIGS. 12A and 12B.

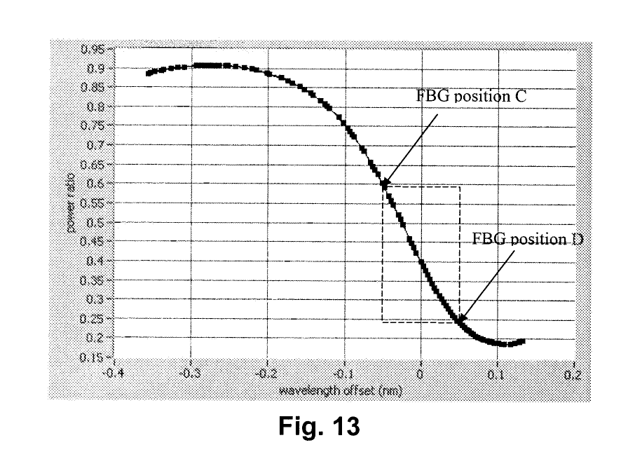

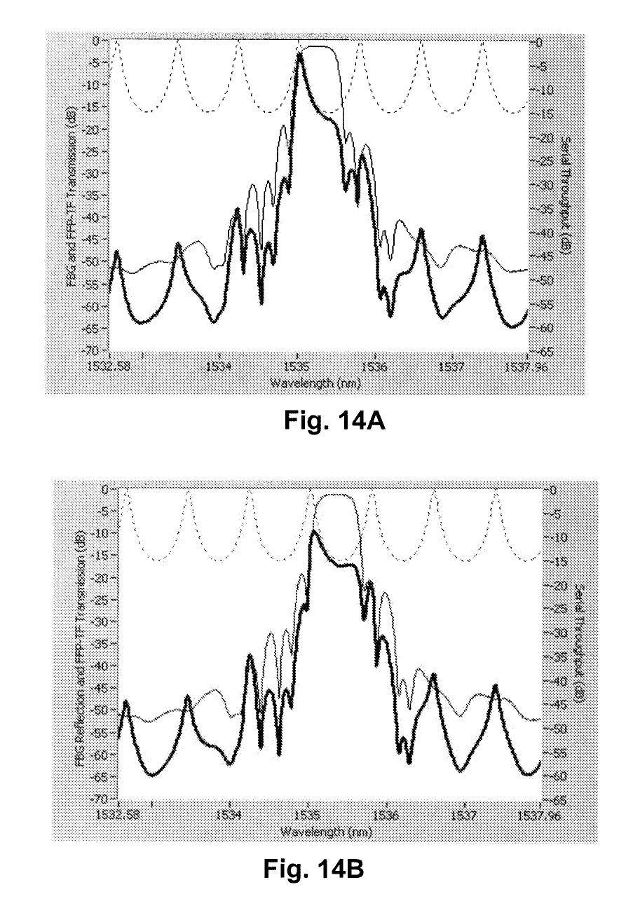

FIG. 13 shows a judicious selection of the calibration curve of FIG. 11, over which good, high sensitivity measurements of wavelength or sensor strain changes can be made. Note that the curve is approximately linear of the selected range, and the range covers the first desired strain range of +/−50 pm. In this configuration, a bias power ratio of 0.4 might, for example, be selected, as that value falls in an area of the curve where contrast and linearity are together optimal for a +/−0.05 nm design range. FIGS. 14A and 14B show spectral models of the upper (position C) and lower (position D) positions of the selected strain ranges from FIG. 13, respectively.

Coupler Selection:

As is seen in FIGS. 12A and 12B, the 0.8 nm FSR, F=10 transmission profile attenuates a significant portion of the 0.5 nm FBG's reflected optical spectrum. At a position of 100 pm from the center of the operating range, approximately twice the designed strain range, the total power through the TF is ˜19% of the power reflected from the FBG. Thus, in order to balance the maximum levels seen on each detector an imbalanced coupler is used to spit the signal between the active channel and the reference channel. To counteract the minimum 19% attenuation by the TF, an 80/20 coupler can, for example, be used. With this selection, 80% of the signal is passed to the active channel or active channels, while the remaining 20% is passed to the reference channel.

In Regime 1, the ratio of the BFG bandwidth to the TF FSR is relatively high 250:800. This means that regardless of the relative spectral positions (offset) of wavelength peaks of the TF and FBG, there is always some significant portion of the FBG optical power transmitted through the combination of the nearest and next-to-nearest FP transmission peak. This limits the total contrast effect of the FFP on the FBG profile, though it does have the positive effect of increasing the portion of the FSR over which acceptably linear changes in attenuation over wavelength offset occur.

For a measurement system for use only in Regime 1, the use of an FBG with less bandwidth, such as a 0.25 nm BW FBG would be preferred. However, the wider 0.5 nm BW sensor is preferred for the preferred embodiment of the system which can be used with the three measurement regimes with a common sensor design. As will be seen below a choice of FBG BW of less than 0.5 nm is not optimal for a system provides good sensor measurement for all three Regimes listed above.

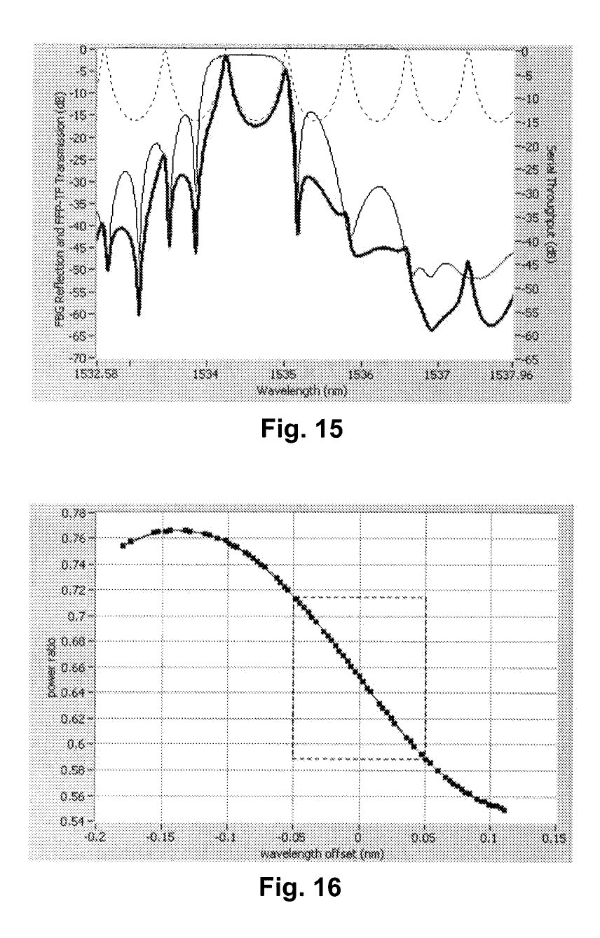

In addition with respect to the choice of FBG bandwidth for Regime 1: If a wider FBG, such as the 1.0 nm BW FBG shown below, is selected, there is not sufficient contrast between the on and off-resonance conditions to facilitate sufficiently sensitive measurements. As is seen in FIG. 15, even at mid-range attenuation, two FFP peaks are passing a significant portion of the FBG signal yielding very poor contrast in the measurement. FIG. 16 shows the calibration curve for a 0.800 nm FSR TF used with a 1.0 nm BW FBG sensor. Over the same +/−0.05 nm range, the contrast of the system as in FIG. 16 is a weak 1.2:1 compared to that of 3.8:1 as in the system as in FIG. 13. For this reason, a 1.0 nm BW FBG is not preferred for Regime 1 measurement.

Regime 3—Measurement Range of +/−5000 pm.

TF selection: F=10, FSR=80 nm.

FBG bandwidth=0.5 nm (same as above for Regime 1)

Coupler Selection:

In Regime 3 (and in contrast to Regime 1) the BW of the TF is significantly wider than the FBG. In Regime 1, the sharp pass band of the TF acted effectively like a minimum 7 dB attenuator (passing a maximum 19%) of the reflected FBG signal. Moreover, the proximity of the next adjacent FP wavelength peak to the FBG reflection dictated that the preferred TF wavelength offset point fall relatively far from direct alignment with the FBG wavelength peak. Because of the width of the FBG peak relative to the FSR of the TF, any changes in FBG wavelength near the peak of the FP do not result in a significant change in total integrated power throughput.

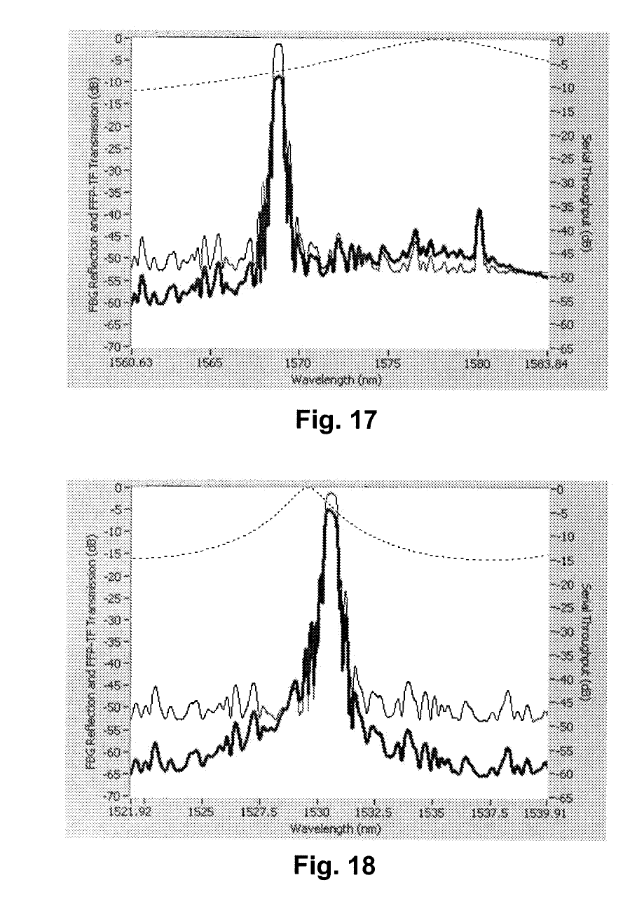

In contrast, as is seen in FIG. 17, due to the wide TF FSR of 80 nm, the BW of the TF is much, much wider than that of the FBG. As such there is no minimum attenuation of the FBG signal due to the TF, as was the case with the narrower TF of Regime 1. Instead, should the wavelengths of the FBG and FFP align, nearly 100% of the FBG signal would successfully pass through the TF. Because the band pass of the TF is wide relative to that of the FBG, the attenuation profile of the TF for the FBG continues to increase sharply at a larger fraction of FSR towards the FP peak than does the combination of Regime 1. Therefore, in Regime 3, it is more effective to operate the TF with its resonance peak more closely aligned (in terms of fractional FSR) to that of the FBG than in Regime 1. These two effects combine to yield a higher output power on the active channel in Regime 3 relative to that of Regime 1. For that reason, a coupler of more even split ratio is preferred for coupling to the reference channel and the one or more active channels. For a system having one reference and one active channel a 50/50 (3 dB) coupler is preferred.

FBG Selection:

In general terms, an FBG with a broader reflection band (BW) will return a higher total integrated power. It would be desirable to have the largest possible BW so that the measurement system is less affected by a given insertion loss to a sensor under test. However, it has been shown that in Regime 1, an FBG sensor bandwidth that is too large relative to the TF FSR reduces contrast to an unacceptable degree. For Regime 1, the 1.0 nm FBG was too wide for the 0.800 nm FSR. A more narrow FBG selection would facilitate better contrast, but with each reduction in FBG bandwidth, a corresponding reduction in returned power from the FBG is seen. In order to multiplexing as many receiver channels as possible for a given broadband light source while avoiding the contrast pitfalls in Regime 1, an FBG bandwidth selection of 0.5 nm is preferred. Should maximizing the multiplexing potential for a given source not be of concern, a narrower FBG could be selected and calibrated.

Regime 2. Measurement range of +/−500 pm.

TF selection: F=10, FSR=16 nm.

FBG bandwidth=0.5 nm.

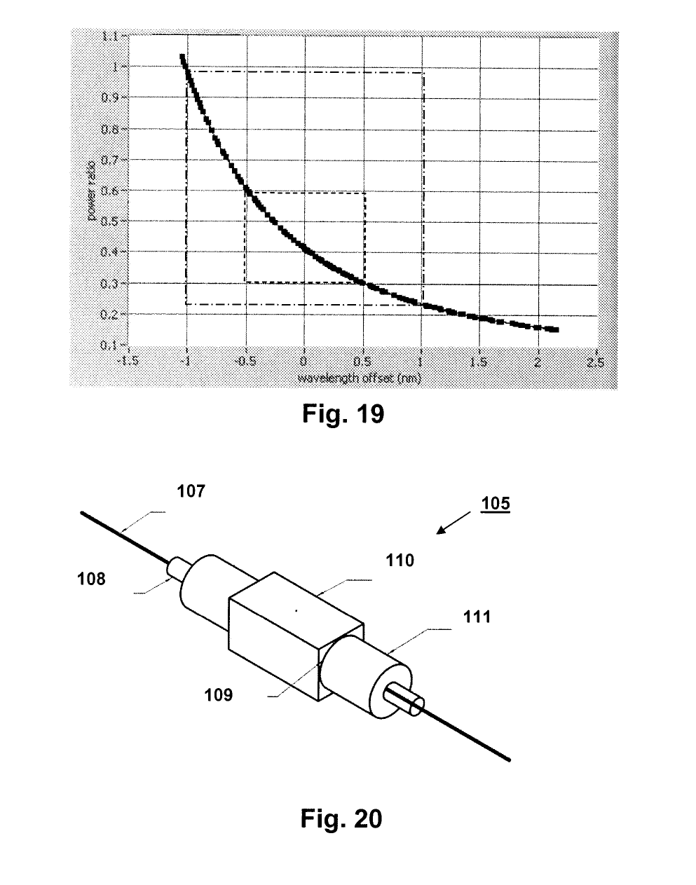

Regime 2 represents any selection of components that exhibit behaviors between Regimes 1 and 3. In an exemplary embodiment, a tunable filter with finesse of 10 and FSR of 16 nm used to implement a measurement system of the invention for measurements in Regime 2. FIG. 18 shows the spectral model of a 16 nm FSR TF offset locked to a 0.5 nm BW FBG sensor. FIG. 19 shows the corresponding calibration curve for that combination of components.

As is seen in FIG. 19, the available wavelength range is either +/−0.5 nm or +/−1.0 nm, depending on the acceptable tolerance for resolution variation. This curve includes a 4:1 split of the optical power as in Regime 1, with 80% of the signal passing through the active channel containing the TF. In this configuration, a bias power ratio of 0.4 might be selected, as that value falls in an area of the curve where contrast and linearity are together optimal for a +/−0.5 nm design range. It can then be seen that the optical power returned through the active channel is nearly identical to that of the reference channel at a wavelength offset of −1 nm from a bias power ratio of 0.4. If the optical power to the reference channel were optimized for maximum optical loss budget, it is at this point of strain that the photodetector of the active channel would enter saturation. It would be possible to select a coupler to provide a split ratio of less than 80/20, for example a 60/40, and push the operating point of the system closer to the peak of the tunable filter.

Optical Source Considerations

In general terms, optical sources preferred for application to the present invention exhibit the following properties:

1. Wide spectral output range. A wider range of emitted wavelength supports a broader choice of optical sensor wavelengths.

2. High optical output power. In practical applications, insertion loss along the fiber sensor path is always of concern. High output power enables the system to withstand practical losses incurred during installation and cabling of sensors in a variety of applications. Moreover, high optical output power enables sharing of a single optical source for a number of detection paths, thereby increasing measurement capabilities for a single source.

3. Spectral flatness. It has been shown that there is a balance in design of the sensing system with respect to measurement range, sensitivity, and optical loss budget. The measurements performed by the system of the invention are ratiometric in nature and are therefore not subject to significant effects from sensor FBG insertion loss. However, as was discussed in the details of the three example measurement regimes, management of the maximum and minimum return powers from the FBG are important for preventing detector saturation and low signal to noise measurements, respectively.

The type and degree of spectral shape requirements vary between one or more of the three example measurement Regimes discussed above. Typical optical sources will exhibit two types of spectral shape non-idealities. The first of these shape phenomena is spectral ripple. Spectral ripple is herein defined as periodic variations in output power over short wavelength intervals, such as 100-500 pm. The systems of the present invention can function as designed with spectral ripple on the order of several 10ths of a dB without issue. First, the 0.5 nm BW sensor FBG of the preferred system that provides good performance over Regimes 1, 2 and 3 integrates much of this spectral ripple prior to detection. Additionally, any residual effects of the ripple are avoided by the ratiometric nature of the measurement itself. In any event, low-ripple optical sources are preferred.

The principal spectral variation of concern for choice of optical sources is spectral flatness. Spectral flatness is typically defined as the region over which an optical source exhibits broadband variation in power less than a prescribed degree, such as 1 or 3 dB. In the systems of the present invention, management of spectral flatness is of particular concern for measurements in Regime 3, as the sensor FBG wavelength itself is expected to change appreciably in the spectral domain: up to 10 nm or so.

If a measurement system of the invention is utilized with a measurement channel designed for use in Regimes 1 or 2, it is acceptable that there be a variation in optical output power over a 1 to 2 nm wavelength range of about 1 dB. In Regime 1, the sensor wavelength is only expected to move ˜100 pm during a measurement cycle. In Regime 2, the sensor wavelength is only expected to move ˜1000 pm during a measurement cycle. If across that wavelength range, the gross variations in the optical source are less than some reasonable expected degree, such as 1 dB, then provisions can be made in the setup of the optical sensing system such that the variation in optical power will neither saturate the detection system nor render measurements of unacceptably low signal to noise ratio.

Thus, many optical sources can serve as adequate optical sources for implementations of Regime 1 or Regime 2 measurements. Examples of such broad band optical sources are Light Emitting Diodes (LEDs), Superluminescent Light Emitting Diodes (SLEDs), and rare earth (e.g., erbium)-doped optical fiber Amplified Spontaneous Emission (ASE sources). Each of these sources offer some degree of advantage over other sources, including cost, size, reliability, total optical output power, optical power stability, electrical power consumption, spectral ripple, and spectral flatness, and degree of polarization. Depending upon the number of sensors to be measured, the degree of optical loss budget required, and the desired cost of materials, any of these sources can serve as a good choice for Regimes 1 and 2.

In a preferred exemplary system implementation, one of the goals is to facilitate a maximum number of measurement channels for a given source, while maintain adequate optical loss budget and good measurement signal to noise ratio.

Practically speaking there are few LEDs available on the market that can provide a sufficient combination of total output power and spectral flatness to meet practical requirements for loss budget and SNR. Therefore, for Regimes 1 and 2, available SLED and ASE sources would both be good choices

In Regime 3, however, it is expected that the FBG sensor may vary as much as 10 nm during a measurement cycle. This fact eliminates most present un-flattened ASE sources from the application, as the typical erbium ASE source can vary as much as 5 dB over a 5-10 nm spectral window. If as the sensor changes wavelength it reflects from the source a region of dramatically higher output power, the system is at risk of detector saturation, rendering the measurement useless. For this reason, broad band SLED sources offer the best combination of spectral flatness, low ripple, and high output power for the preferred exemplary implementation of the measurement system of the invention which can provide good measurement in all three Regimes discussed.

It will be appreciated that an analysis analogous to that described herein can be applied to select optical components of the systems herein for use in any of Regimes 1, 2 or 3, subranges thereof or any combinations of such ranges.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, a wavelength range, a range of component properties or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

The invention illustratively described herein suitably may be practiced in the absence of any element or elements, limitation or limitations which is not specifically disclosed herein.

One of ordinary skill in the art will appreciate that materials, substrates, device elements, light sources, light detectors, calibration methods, spectroscopic methods and analytical methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art. For example, when a compound is claimed, it should be understood that compounds known in the art including the compounds disclosed in the references disclosed herein are not intended to be included in the claim.

All references cited herein are hereby incorporated by reference to the extent that there is no inconsistency with the disclosure of this specification. Some references provided herein are incorporated by reference to provide details concerning device elements, device configurations, designs of FP filters, designs of FFP filters, optical sources, optical sensor designs and methods of analysis of device performance and additional uses of the invention.

1. A sensor interrogation system for measurement of high frequency changes in center wavelengths of one or more than one optical sensors which comprises:
a broadband source for providing broadband output to one or more than one optical sensor;
one or more than one sensor measurement arm, each arm for receiving the output of one optical sensor, wherein a measurement arm comprises a reference channel and one or more active channels wherein the reference channel comprises a reference photodetector and each active channel comprises a fiber Fabry-Perot tunable filter and a photodetector; and
electronic control for tuning the wavelength of the fiber Fabry-Perot tunable filter and for data acquisition and processing;
wherein the optical output of the source is optically coupled to the one or more optical sensor and the reflected output of each of the one or more optical sensor is optically coupled into one of the one or more measurement arms, in each measurement arm the reflected output of one optical sensor is coupled into the reference channel and the one or more active channels of one measurement arm, the reflected output of the optical sensor coupled into the reference channel is detected at the reference photodetector and the reflected output of the same optical sensor coupled into the one or more active channels is passed through the fiber Fabry-Perot tunable filter of each active channel prior to detection at the photodetector of an active channel, wherein the wavelength of each fiber Fabry-Perot tunable filter is selected such that it is offset at a selected wavelength offset from the average peak of the center wavelength of the optical sensor that is optically coupled to that fiber Fabry-Perot tunable filter over the course of a measurement period and wherein the offset of the fiber Fabry-Perot is periodically maintained by the electronic control, and wherein a measurement of the change in the ratio of optical power of an active channel to the reference channel provides a measurement of the change in center wavelength of each of the one or more optical sensors.

2. The sensor interrogation system of claim 1 wherein the fiber Fabry-Perot tunable filter has a finesse of 8-12.

3. The sensor interrogation system of claim 1 wherein the FSR of the fiber Fabry-Perot tunable filter ranges from 0.5-100 nm.

4. The sensor interrogation system of claim 1 wherein the ratio of the output of the optical sensor coupled into the reference channel to that coupled into the one or more active channels of a measurement arm is selected to balance the output of the reference and active channels.

5. The sensor interrogation system of claim 4 wherein the ratio of the output of the optical sensor coupled into the reference channel to that coupled into the one or more active channels of a measurement arm ranges from 1:1 to 1:4.

6. The sensor interrogation system of claim 1 wherein the broadband source is a light emitting diode (LED), a superluminescent LED or an amplified spontaneous emission (ASE) source.

7. The sensor interrogation system of claim 1 having one active channel wherein the fiber Fabry-Perot tunable filter of the FSR is between 0.6 and 1 nm, between 12 and 20 nm, or between 60-100 nm.

8. The sensor interrogation system of claim 1 wherein the measurement arm contains more than one active channel.

9. The sensor interrogation system of claim 8 wherein the fiber Fabry-Perot tunable filters of each active channel have the same finesse but different FSR.

10. The sensor interrogation system of claim 8 wherein at least one active channel comprises a fiber Fabry-Perot tunable filter having FSR between 0.6 and 1 nm, one active channel having a fiber Fabry-Perot tunable filter having FSR between 12 and 20 nm, and one active channel having a fiber Fabry-Perot tunable filter having FSR between 60-100 nm.

11. The sensor interrogation system of claim 1 wherein the electronic control allows for continuous, asynchronous control of the offset of the fiber Fabry-Perot tunable filters independent from data acquisition and processing.

12. The sensor interrogation system of claim 1 wherein a change in the ratio of optical power of an active channel to the reference channel coupled to an optical sensor is related to the wavelength change of the optical sensor by a calibrated relationship between power ratio and relative wavelength change.

13. The sensor interrogation system of claim 1 wherein the wavelength change of an optical sensor is calibrated to a change in strain on the optical sensor or a change in temperature of the optical sensor.

14. A sensor system sensor interrogation system of claim 1 and one or more optical sensors.

15. The sensor system of claim 14 wherein the optical sensors each comprise a fiber Bragg grating.

16. The sensor system of claim 15 wherein the fiber Bragg gratings of the optical sensors have BW of 0.25 to 1.0.

17. The sensor system of claim 15 wherein the fiber Bragg gratings of the optical sensors have BW of 0.50.

18. A method for interrogating one or more optical sensors to detect changes in center wavelengths thereof which comprises the steps of:
(a) coupling output from a broadband source into the one or more optical sensors;
(b) coupling reflected output from each of the one or more optical sensors into a measurement arm of a sensor interrogation system of any one of claims 1-14
(c) for each measurement arm determining the ratio of optical power passing through the reference channel and each active channel at a selected high frequency over a selected time period thereby detecting changes in the center wavelength of the optical sensor coupled to the measurement arm over that time period;
(d) for each measurement arm and each active channel of a measurement arm periodically calculating an average change in center wavelength of the optical sensor coupled to a measurement arm using the power ratios determined in step c and using the average change in center wavelength to assess for each active channel if the peak wavelength of the fiber Fabry-Perot filter of the active channel is offset at the selected wavelength difference from the average peak of the center wavelength of the optical sensor over the course of a measurement period, and
(e) if necessary, tuning the wavelength of each of the one or more fiber Fabry-Perot filters of each measurement arm so that each fiber Fabry-Perot filter of each active channel and each measurement arm to maintain the selected offset;
wherein power ratio data is collected for the measurement of the change in center wavelength of each optical sensor only from those active channels in which the wavelength of the fiber Fabry-Perot filter of the active channel is maintained at the selected offset, and wherein a measurement of the change in the ratio of optical power of an active channel to the reference channel provides a measurement of the change in center wavelength of each of the one or more optical sensors.

19. The method of claim 18 wherein a change in the ratio of optical power of an active channel to the reference channel coupled to an optical sensor is related to the wavelength change of the optical sensor by a calibrated relationship between power ratio and relative wavelength change.

20. The method of claim 18 wherein the wavelength change of an optical sensor is calibrated to a change in strain on the optical sensor or a change in temperature of the optical sensor.

21. A method for detecting high frequency changes in strain in an object under test which comprises:
(a) positioning one or more optical strain sensor in contact with the object under test;
(b) coupling output from a broadband source into the one or more optical strain sensors;
(c) coupling reflected output from each of the one or more optical strain sensors into a measurement arm of a sensor interrogation system of any one of claims 1-13;
(d) for each measurement arm, determining the ratio of optical power passing through the reference channel and each active channel at a selected high frequency over a selected time period thereby detecting changes in the center wavelength of the output of the optical strain sensor coupled to the measurement arm over that time period;
(e) for each measurement arm and each active channel of a measurement arm periodically calculating an average change in center wavelength of the output of the optical sensor coupled to the measurement arm using the power ratios determined in step c and using the average change in center wavelength to assess, for each active channel, if the peak wavelength of the fiber Fabry-Perot filter of that active channel is offset at the selected wavelength offset from the peak of the center wavelength of the output of the optical strain sensor, and
(f) if necessary, tuning the wavelength of each of the one or more fiber Fabry-Perot filters of each measurement arm so that each fiber Fabry-Perot filter of each active channel and each measurement arm to maintain the selected offset;
wherein power ratio data for the measurement of the change in center wavelength of each optical sensor only from those active channels in which the wavelength of the fiber Fabry-Perot filter of the active channel is maintained at the selected offset, the power ratio data providing a measurement of strain in the object under test over the time of data collection.

22. The method of claim 21 wherein a change in the ratio of optical power of an active channel to the reference channel coupled to an optical sensor is related to the wavelength change of the optical sensor by a first calibration relationship between power ratio and relative wavelength change and the wavelength change of an optical sensor is related to strain on the optical sensor by a second calibration relationship.
